(19) United States
(12) Patent Application Publication
(10) Pub. No.: US 2020/0161720 A1
(43) Pub. Date: May 21, 2020

(54) ELECTRODES AND ELECTROCHEMICAL CELLS WITH EFFICIENT GAS HANDLING PROPERTIES

(71) Applicant: AQUAHYDREX PTY LTD, New South Wales (AU)

(72) Inventors: Gerhard Frederick SWIEGERS, New South Wales (AU); Scott JANSEN, Louisville, CO (US); Nathan SCHUH, Louisville, CO (US); Jared James Cullen SMITH, New South Wales (AU); Adrian Allan GESTOS, New South Wales (AU); James Scott GREER, New South Wales (AU); Mark Simbajon ROMANO, New South Wales (AU); Prerna TIWARI, New South Wales (AU)

(73) Assignee: AQUAHYDREX PTY LTD, New South Wales (AU)

(21) Appl. No.: 16/615,602

(22) PCT Filed: May 25, 2018
(86) PCT No.: PCT/AU2018/050506

§ 371 Date: Nov. 21, 2019

Related U.S. Application Data
(60) Provisional application No. 62/511,550, filed on May 26, 2017.
(60) Provisional application No. 62/511,574, filed on May 26, 2017.

(51) Int. Cl. H01M 10/52; H01M 4/36; H01M 4/88; H01M 4/86; H01M 10/42

(52) U.S. Cl. CPC H01M 10/526; H01M 4/366; H01M 10/4235; H01M 4/8663; H01M 4/8807

(57) ABSTRACT

An electrode (110) for an electrochemical cell, comprising a conductive, porous, hydrophilic, gas-permeable and a liquid-permeable liquid-side layer (111) having a liquid-facing side (116), and a non-conductive, porous, hydrophobic, gas-permeable and liquid-impermeable gas-side layer (112) having a gas-facing side (117). Gas-producing electrochemical reactions are promoted at an interface (115) between the liquid-side layer (111) and the gas-side layer (112) by a beneficial relationship of capillary pressures of the electrode layers. The liquid-side layer (111) exhibits a repulsive capillary pressure in the liquid electrolyte (113) of the cell (110) and the gas-side layer exhibits an attractive capillary pressure in the liquid electrolyte (113).

### FIELD

The invention relates to electrochemical cells, and particularly to electrodes and cell structures that minimize or reduce the presence of gas bubbles in liquid or gel electrolytes in electrochemical cells mediating liquid-gas transformations.

### BACKGROUND

Numerous electrochemical cells facilitate liquid-to-gas or gas-to-liquid transformations that involve the formation of, or presence of gas bubbles in liquid electrolyte solutions. For example, electrochemical cells used in the chlor-alkali process typically generate chlorine gas and hydrogen gas in the form of bubbles at the positive electrode and negative electrode, respectively.

Bubbles in an electrochemical cell generally complicate electrochemical liquid-to-gas or gas-to-liquid transformations by, for example, increasing the electrical energy required to undertake the chemical transformation in the cell. This arises from effects including “bubble overpotential,” “bubble curtains,” and “voidage.”

The term “bubble overpotential” refers to the additional energy required to produce gas bubbles at an electrode. The bubble overpotential can be a substantial portion of cell voltage. For example, the bubble overpotential in electrochemical chlorate manufacture can be about 0.1 V of the cell voltage.

When bubbles are present they often form a “bubble curtain” at the three-way solid-liquid-gas interface of an electrode. This “bubble curtain” (or “bubble coverage”) typically impedes movement of electrolyte between the electrodes to the electrode surface, slowing or even halting the reaction. The bubble-curtain may also reduce the conductive cross-section through the electrolyte between the electrodes, increasing the cell resistance.

When bubbles are released from an electrode surface into, for example, a liquid electrolyte, they may act as non-conducting voids within the conduction pathway between the two electrodes, thereby increasing the electrical resistance of the cell. This effect, which is known as “voidage”, may substantially increase the cell voltage (e.g. by up to about 0.6 V in electrochemical chlorate manufacture).

As a result of these and other issues, new or improved structures, devices, electrodes, cells and/or methods that prevent or diminish the formation of gas bubbles in liquid or gel electrolytes during liquid-to-gas or gas-to-liquid transformations are of interest.

### SUMMARY

This Summary is provided to introduce a selection of concepts in a simplified form that are further described below. This Summary is not intended to identify all of the key features or essential features of the claimed subject matter, nor is it intended to be used to limit the scope of the claimed subject matter.

The present invention, in various aspects, derives from the unexpected discovery by the inventors that a repulsive capillary action can be utilized to direct gas formation away from an inter-electrode region in a porous electrode within a gas-liquid electrochemical cell (or a gas-gel electrochemical cell). For example, a porous hydrophobic material or surface, having or displaying a repulsive capillary action toward water, can be utilized within, or as part of, a porous electrode infused with water, to favor gas formation at that location and draw gases into the porous hydrophobic material or surface. In cases where gas is externally provided to the electrode as a reaction feedstock, the porous hydrophobic material or surface, can also be used to hold gases within the porous hydrophobic material and facilitate gas retention at that location.

In one example, there is provided an electrochemical cell, comprising a liquid electrolyte and a first electrode in contact with the liquid electrolyte. The first electrode comprises a liquid-side layer having a first surface in direct contact with a gas-side layer. In one embodiment, the gas side layer is made of a material exhibiting a negative (attractive) capillary pressure with the liquid electrolyte and the liquid side layer is made of a material exhibiting a positive (repulsive) capillary pressure with the liquid electrolyte.

In another embodiment, the gas side layer is made of a material exhibiting a capillary pressure with the electrolyte more negative than −0.1 bar. The liquid-side layer is made of a material exhibiting a capillary pressure with the electrolyte more positive than +0.1 bar. A gradient of capillary pressure in the electrolyte between the liquid-side layer and the gas-side layer is greater than or equal to one bar.

In a particular non-limiting example, the capillary pressure of a material is twice a surface tension of the electrolyte multiplied by the cosine of a contact angle of the electrolyte with the material, divided by an average pore radius of the material. In another particular non-limiting example, the electrochemical cell further comprises a hydrophilic non-conductive bubble-suppression layer at least partially infused with electrolyte and in direct contact with a second surface of the liquid-side layer opposite the first side of the liquid-side layer, the bubble-suppression layer made of a material exhibiting a capillary pressure with the electrolyte more positive than the liquid-side layer capillary pressure.

Optionally, the bubble-suppression layer is made of an unmodified polyethersulfone membrane. Optionally, the gas-side layer comprises an expanded polytetrafluoroethylene (ePTFE) membrane. Optionally, the liquid-side layer comprises a catalyst material and fibrillated strands of PTFE entangling structures in the gas-side layer. Optionally, the liquid-side layer comprises a catalyst material and fibrillated strands of PTFE entangling structures of a bubble-suppression layer in contact with the liquid-side layer opposite the gas-side layer. Optionally, the liquid-side layer has a higher density of fibrillated PTFE strands adjacent to its first side than its second side. Optionally, the liquid-side layer has a uniform density of fibrillated. PTFE strands throughout its thickness. Optionally, the liquid-side layer has a higher density of fibrillated PTFE strands adjacent to its second side than its first side. Optionally, the electrolyte is a 6 M aqueous solution of potassium hydroxide (KOH). Optionally, the liquid-side layer comprises conductive particles. Optionally, the liquid-side layer comprises a conductive substrate. Optionally, the liquid-side layer has a different porosity, average pore size, hydrophobicity, or thickness than the gas-side layer.

In another particular non-limiting example, the electrochemical cell further comprises a heating element configured to heat the first electrode and a controller to maintain the first electrode at a different temperature than a counter-electrode. Optionally, a fluid pressure of the electrolyte is greater than a gas pressure in a gas space adjacent to the gas-side layer. Optionally, the second side of the liquid-side layer of the first electrode directly contacts a hydrophilic bubble-suppression layer exhibiting a capillary pressure with the electrolyte more positive than the liquid-side layer capillary pressure, and further comprising a second electrode with a liquid-side layer directly contacting the bubble-suppression layer. Optionally, the bubble-suppression layer is a single layer of unmodified polyethersulfone membrane. Optionally, the bubble-suppression layer is multiple layers of unmodified polyethersulfone membrane. Optionally, the bubble-suppression layer is less than 2mm thick.

In another example, there is provided a method of operating an example electrochemical cell, comprising asymmetrically heating or cooling the first electrode while electrochemical reactions occur in the cell.

In another example, there is provided a method of operating an example electrochemical cell, wherein the electrolyte comprises seawater and comprising electrolyzing the seawater to produce oxygen without producing chlorine gas.

In another example, there is provided a method of making a gas diffusion electrode, the method comprising preparing a mixture of PTFE powder and a catalyst material, and applying the mixture to a surface of a bubble-suppression layer material while applying a shear force between the mixture and the bubble-suppression layer, to thereby fibrillate PTFE particles at the bubble-suppression layer surface. After applying the mixture to the bubble-suppression layer, pressing a conductive substrate into the mixture.

Optionally, the method further comprises, after pressing the conductive substrate into the mixture, pressing an expanded PTFE membrane onto the mixture while applying a shear force to thereby fibrillate PTFE particles at a surface of the expanded PTFE membrane.

In another example, there is provided a method of making a gas diffusion electrode, the method comprising preparing a mixture of PTFE powder and a catalyst material, applying the mixture to a surface of an expanded PTFE membrane while applying a shear force between the mixture and the expanded PTFE membrane, to thereby fibrillate PTFE particles at the expanded PTFE membrane surface. After applying the mixture to the expanded PTFE membrane, pressing a conductive substrate into the mixture.

Optionally, the method further comprises, after pressing the conductive substrate into the mixture, pressing a bubble suppression layer onto the mixture while applying a shear force to thereby fibrillate PTFE particles at a surface of the bubble suppression layer.

### BRIEF DESCRIPTION OF THE FIGURES

Although various example embodiments will be apparent from the following Detailed Description, such example embodiments are not intended to limit the scope of the invention, which is only to be limited by the Claims. The description of various illustrative example embodiments set forth in the following Detailed Description may make reference to the attached drawings, of which:

FIG. 1 schematically depicts an example porous electrode in a liquid electrolyte.

FIG. 2 schematically depicts: (A) an example gas diffusion electrode, and (B) an example electrochemical cell electrode.

FIG. 3 schematically depicts: (A) an example electrochemical cell, and (B) another example electrochemical cell.

FIG. 4 depicts: (A) a Scanning Electron Micrograph (SEM) of an example embodiment liquid side layer, showing the presence of a network of fine fibrils of PTFE and an open-pored overall structure, and (B) a schematic illustration in cross-section.

FIG. 5 schematically depicts the surface of the liquid side layer of an example embodiment gas diffusion electrode during operation at 300 mA/cm² as a hydrogen generating negative electrode in a water electrolyser, with (A) no overpressure applied (the surface is coated with many bubbles, depicted by the round circles), (B) an overpressure of 0.4 bar applied (only bubbles on one edge), and (C) the bottom edge of the electrode treated to avoid bubble formation (no bubbles visible).

FIG. 6 schematically depicts the example embodiment gas diffusion electrode in FIG. 5: (A) before, and (B) after a gas suppression layer is affixed over it, operating at 300 mA/cm² as a hydrogen generating negative electrode in a water electrolyser with no overpressure applied. Note that no bubbles (depicted by the round circles) are visible in (B).

FIG. 7 shows chronoamperograms at 10 mA/cm² of electrolysers operating at 80° C. and comprising: (A) Raney Ni+CB+PTFE+Ni-mesh/Gortex membrane (an expanded polytetrafluoroethylene (ePTFE) membrane) (negative electrode) and NiCo₂O₄+PTFE+Ni-mesh/ePTFE membrane (positive electrode), and (B) 10% Pt/CB+PTFE+Ni-mesh/ePTFE membrane (negative electrode) and NiCo₂O₄+PTFE+Ni-mesh/ePTFE membrane (positive electrode).

FIG. 8 depicts: (A) current-voltage curves for the Raney Ni+CB+PTFE+Ni-mesh/ePTFE membrane (negative electrode) and NiCo₂O₄+PTFE+Ni-mesh/ePTFE membrane (positive electrode) electrolyser (6 M KOH electrolyte) at different temperatures, and (B) the data at 80° C. (solid line) compared to interpolations of alkaline (dashed line) and PEM (dotted line) electrolysers having the lowest recorded onset potentials at the same temperature.

FIG. 9 shows graphs of overpotential as a function of current density and temperature for Raney Ni+CB+PTFE+Ni-mesh/ePTFE membrane (negative electrode) and NiCo₂O₄+PTFE+Ni-mesh/ePTFE membrane (positive electrode) electrolyser (6 M KOH electrolyte; 80° C.) at: (A) the hydrogen-generating negative electrode, and (B) the oxygen-generating positive electrode.

FIG. 10 show polarisation curves after 1 hour of cells in fuel cell mode at 80° C. (6 M KOH electrolyte; 10 mm inter-electrode gap) having: (A) 20% Pd—Pt/CB+PTFE+Ni-mesh/ePTFE membrane at both the H₂ and O₂ electrodes; and (B) 20% Pd—Pt/CB+PTFE+Ni-mesh/ePTFE membrane at the H₂ electrode and carbon black+Ni-mesh/ePTFE membrane at the O₂ electrode.

FIG. 11 depicts chronoamperograms at −1.26 V and then −1.24 V cell voltages, of an electrolyser operating at 80° C. and filled with borate-buffered seawater (measured pH 8.788), comprising: 10% Pt/CB+PTFE+Ni-mesh/ePTFE membrane (negative electrode) and NiCo₂O₄+PTFE+Ni-mesh/ePTFE membrane (positive electrode).

FIG. 12 depicts chronoamperograms at −1.26 V cell voltage of electrolysers with 10% Pt/CB+PTFE+Ni-mesh/ePTFE membrane (as the negative electrode) and NiCo₂O₄+PTFE+Ni-mesh/ePTFE membrane (as the positive electrode) operating at 80° C. and filled with: (A) borate-buffered 0.3 M NaCl solution (pH 8.80), and (B) 0.3 M NaCl solution without borate buffer (pH 7.60).

### DETAILED DESCRIPTION

The following modes, features or aspects, given by way of example only, are described in order to provide a more precise understanding of the subject matter of a preferred embodiment or embodiments.

Various embodiments herein provide electrochemical cells optimized for performing liquid-to-gas and/or gas-to-liquid transformations while minimizing the deleterious impact of gas bubbles in liquid or gel electrolytes and promoting efficient transportation of gases through electrode structures. In some embodiments, such cells may be created by producing electrode and cell structures that exhibit capillary pressure relationships that promote the transportation of gases through electrolyte-submerged electrode structures. In particular, cells may be configured so as to exhibit a gradient of capillary pressures from substantially positive at an inter-electrode region to substantially negative at a gas-removal region. Various example methods of making and operating such electrodes and cells are also provided.

As described above, the formation of bubbles in an electrochemical cell can be detrimental to cell performance, particularly if the bubbles are formed at or adjacent to the inter-electrode region (defined as the region between a positive electrode and a negative electrode separated by an ion-conductive separator). Therefore, if the formation of bubbles can be minimized or directed away from the inter-electrode space, then cell performance may be improved. The inventors have found that capillary actions and capillary pressures may be leveraged toward both of these objectives.

Although many of the examples herein are described with reference to water electrolysis cells, the described structures, methods and principles may also be applied to other gas-producing electrolysis cells or to gas-consuming electrochemical cells such as fuel cells.

### Definitions

Electrochemical cells of the type described herein may generally use liquid electrolytes. As used herein, the term “liquid electrolyte” may include acidic aqueous solutions, alkaline aqueous solutions, neutral or near-neutral pH aqueous solutions, de-ionized water, ionic liquids, or gel electrolytes (i.e., electrolyte solutions exhibiting cohesive properties similar to solids along with ionic diffusivity properties similar to liquids).

Various electrolytes may be used in combination with the electrodes and electrochemical cells described herein. For example, electrolytes used may include alkaline electrolytes such as potassium hydroxide (KOH), sodium hydroxide (NaOH), lithium hydroxide (LiOH), barium hydroxide (Ba(OH)₂), calcium hydroxide (Ca(OH)₂), or combinations of these or other aqueous bases. Electrolytes may also comprise acidic electrolytes such as hydrochloric acid (HCl), sulfuric acid (H₂SO₄), hydrobromic acid (HBr), nitric acid (HNO₃), chloric acid (HClO₃), perchloric acid (HClO₄), hydrofluoric acid (HF), phosphoric acid (H₃PO₄), or combinations of these and/or other acids. In other embodiments, electrolytes may comprise non-aqueous electrolytes, ionic liquid electrolytes, aqueous salt solution electrolytes, or mixtures or combinations of any of the above.

As used herein, a material that is described as “conductive” has a general property of being able to conduct electrons or electric current. In other words, a “conductive” material has a substantial degree of electrical conductivity. Such “conductive” materials may include materials generally known to be “semi-conductive” as well as those known to be “highly conductive.” In general, “conductive” materials should be understood to stand in contrast to “electrically insulative” or “electrically non-conductive” materials that do not generally conduct electrons under the operating conditions of the systems and materials described herein.

As the terms are used herein, a substance or material is defined to be ‘electro-active’ if it undergoes or facilitates electrochemical processes when subjected to a suitable voltage bias. A substance or material is ‘electro-inactive’ if it does not undergo or facilitate electrochemical processes when subjected to a suitable voltage bias.

A gas diffusion electrode is defined as an electrode with a conjunction of a solid, liquid and gaseous interface, and an electrical conducting catalyst supporting an electrochemical reaction between the liquid and gaseous phase. A “front” or “inter-electrode” side of the gas diffusion electrode interfaces with a liquid electrolyte and faces a counter-electrode. A “rear” or “outer” side of the electrode interfaces with a gas chamber that contains gas and no liquid. When installed in electrochemical cells, the “rear” or gas-side of a gas diffusion electrode is typically sealed against a frame so as to prevent electrolyte from flooding the gas chamber. The region between the liquid-facing side and the gas-facing side of the electrode typically contains at least two layers, namely: (i) a conductive “catalyst” layer that faces the liquid electrolyte and abuts (ii) a “gas diffusion layer” that faces the gas chamber.

For convenience, the conductive catalyst layer may be referred to as a “liquid-side layer” and the gas diffusion layer may be referred to as a “gas-side layer”. Liquid electrolyte typically penetrates somewhat but not all the way into the catalyst layer. Gas from the gas side also penetrates through the gas diffusion layer into the catalyst layer from the back side.

The objective of this configuration is generally understood to create and maintain a three-phase solid-liquid-gas boundary (also referred to herein as the “three-phase boundary”) within the catalyst layer along a region at which the liquid electrolyte interfaces with the reactant/product gas in the presence of the solid catalyst. Reaction at the three-phase boundary is driven by electron flow to or from the current carrier, through the conductive catalyst and gas diffusion layers, causing either production or consumption of the gas.

In embodiments in which the catalyst layer is predominantly made of a micro-porous material, capillary effects of the type discussed below may constitute an important parameter that may be controlled in gas diffusion electrodes in order to create and maintain a suitable three-phase boundary.

A material is defined here as being porous if it has many small holes in it, so liquid or air can pass through it. The porosity of a material may be quantified as the ratio of total pore volume to the bulk volume of a material represented as a percent. In example embodiments, a material described as “porous” may have, in its dry state, a porosity of less than or equal to 90% porous, less than or equal to 80% porous, less than or equal to 60% porous, less than or equal to 50% porous, less than or equal to 40% porous, less than or equal to 30% porous, less than or equal to 20% porous, less than or equal to 10% porous, less than or equal to 5% porous, or less than or equal to 1% porous.

A material is defined here as being gas-porous or gas-permeable if gas is able to freely pass through the material. A material is defined here as being gas-impermeable if gas is substantially prevented from passing through the material due to the nature or structure of the material. Similarly, a material is referred to herein as being liquid-porous or liquid-permeable if the material substantially allows liquid to pass through, while a material is defined as being liquid-impermeable if liquid is prevented from passing through the material due to the nature, structure, or properties of the material.

### Capillary Action and Pressure

The term “capillary action” refers to the ability of a liquid to spontaneously flow in narrow spaces against external forces like gravity. An attractive capillary action is observed when, for example, water is attracted to and spontaneously climbs the walls of a glass capillary tube, forming a concave meniscus. A repulsive capillary action is observed when a liquid like mercury is repelled by the walls of a glass capillary tube, forming a convex meniscus.

Capillary pressure is the equivalent external pressure that would be needed to counteract the motion caused by the capillary action. In the case of an attractive capillary action, the capillary pressure is formally a positive number. For a repulsive capillary action, the capillary pressure is formally a negative number. The mathematical sign (positive or negative) denotes only the direction of the capillary pressure; namely, that it is directed toward or away from the object.

As used herein, the terms “attractive capillary action” and “repulsive capillary action” refer to the interaction that would occur with water. A capillary action is defined to be “attractive” if it attracts water. It is defined to be “repulsive” if it repels water. Water will generally be attracted to and drawn up the walls of a capillary tube if those walls are hydrophilic (‘water-loving’). Water will generally be repelled by and retreat from the walls of a capillary tube if those walls are hydrophobic (‘water-repelling’).

Hydrophilicity and hydrophobicity are generally defined in terms of their “contact angle” with water. The term “contact angle” refers to an angle created by a liquid in contact with a solid surface. This angle is influenced by intermolecular cohesion and adhesion forces between the solid and the liquid as they interact. The balance between the cohesive forces of similar molecules such as between the liquid molecules (e.g., hydrogen bonds and Van der Waals forces) and the adhesive forces between dissimilar molecules such as between the liquid and solid molecules (e.g., mechanical and electrostatic forces) will determine the contact angle created in the solid-liquid interface. The traditional definition of a contact angle is the angle a liquid creates with the solid or liquid when the liquid is deposited on the solid.

As suggested above, the contact angle of a liquid with a solid material may partly depend on properties of the liquid as well as the material. Therefore, an aqueous electrolyte may have a different contact angle with a material than water at the same temperature.

Nonetheless, as the terms are used herein, a “hydrophilic” material is defined as having a contact angle with water that is less than or equal to 90° at standard temperature and pressure, while a “hydrophobic” material is defined as having a contact angle with water that is greater than 90° at standard temperature and pressure.

Capillary actions and pressures are typically larger for narrower than wider spaces. For example, materials with small pore diameters will typically have higher capillary pressures than the same material with large pore diameters.

Capillary pressures in porous materials can be calculated using the Young-Laplace equation:

P_{c}=2/r cos (1)

where P_{c} is the capillary pressure, r is the average pore radius within the porous material, γ is the surface tension of the liquid, and θ=the contact angle of the liquid with the material from which the porous structure is composed.

Surface tension, typically measured in units of newtons per meter (N/m) is a property of a fluid representing elastic tension created by the attraction of particles making up the fluid. The surface tension of a fluid may vary depending on the temperature, pressure, and solute concentration of the fluid.

As indicated above, a wide range of liquids or gels may be used as electrolytes with electrochemical cells and electrodes as described herein. In some embodiments, a capillary pressure of an electrode material or cell component material may be defined in a standardized manner with water as the liquid for determining the values of surface tension and contact angle. In other embodiments, a capillary pressure of an electrode material or cell component material may be defined with reference to a specified electrolyte as the liquid for determining the values of surface tension and contact angle. In still other embodiments, a capillary pressure of an electrode material or cell component material may be defined with reference to a specified electrolyte as the liquid for determining one of the values of surface tension or contact angle and with reference to water for the other of these values.

Unless otherwise specified, capillary pressures reported herein are based on the use of a liquid aqueous electrolyte of 6 M KOH (six molar potassium hydroxide) at 60° C. under atmospheric pressure. Equivalent capillary pressures for other electrolytes and under other physical conditions may be imputed from these values.

### Capillary Pressures in Conventional Multi-Layer, Porous Electrodes

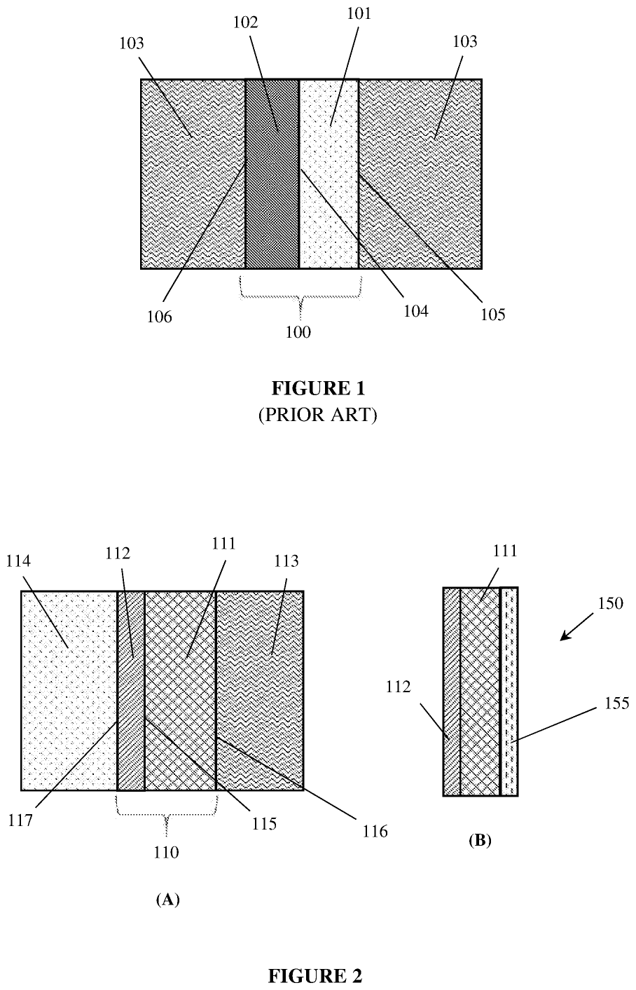

FIG. 1 illustrates a conventional multi-layer, porous electrode 100 submerged in an electrolyte 103. The multi-layer electrode 100 includes a porous, conducting layer 101, coated with a thin layer of a more finely pored, non-conducting layer 102.

A “front” or “inter-electrode” side 106 of the multi-layer electrode 100 interfaces with the electrolyte 103 and faces a counter-electrode (not shown) with which the electrode 100 may exchange ions via the electrolyte 103 while electrochemical reactions occur. A “rear” or “back” side 105 of the multi-layer, porous electrode 100 interfaces with the electrolyte 103 and faces away from the counter-electrode (not shown).

While the electrode 100 of FIG. 1 is a “porous electrode,” it is not a “gas diffusion electrode” (as these terms are used herein) because the back side 105 of the multi-layer electrode 100 is submerged in electrolyte 103 with any produced gases escaping to the headspace above the electrode as bubbles rising up through the electrolyte adjacent the back side 105 of the electrode.

The objective of this configuration is generally understood to re-direct gas bubble formation away from the inter-electrode region and interface 106 to the “back-side” of the electrode at interface 105, thereby keeping the inter-electrode space clear of bubbles. In this way, many of the deleterious effects of gas bubbles in an electrochemical cell can be mitigated.

Conventional multi-layer porous electrodes, such as that illustrated in FIG. 1, exhibit capillary pressure gradients that decrease the probability of bubble formation within the inter-electrode space and increase the probability of gas bubble formation on the rear, outer face that does not form part of the inter-electrode space. This is illustrated by the following example described with reference to FIG. 1.

In this example, the electrode 100 is surrounded by an open solution 103 comprising aqueous 6 M KOH at a temperature of 60° C. and an ambient pressure of atmospheric (1 bar). The liquid solution 103 is also infused into and throughout the porous structures 101 and 102.

For the purposes of this example, the non-conducting layer 102 will be considered to have an average pore radius of 0.1 μm (average pore diameter=0.2 μm). The electrolyte 103 (6 M KOH) has a surface tension y of about 0.078409 N/m at 60° C. If the contact angle of the electrolyte with the insulating layer at that temperature is 5°, then the capillary pressure, P_{c}, can be calculated using equation (1) to be +1,562,213 N/m², which equates to +15.6 bar. Therefore, the capillary pressure, P_{c}, in the non-conducting layer is a positive number, meaning that the aqueous KOH solution 103 is attracted to, and drawn into the pores of the non-conducting layer 102 by the capillary action.

For the purposes of this example, the porous conducting layer 101 will be considered to comprise a hydrophilic, conductive material having an average pore radius of 1 μm (average pore diameter=2 μm), which is 10-times larger than the pores of the non-conductive layer 102. If the contact angle of the electrolyte with the porous electrode is also 5°, then the capillary pressure, P_{c}, can be calculated using equation (1) to be +156,221 N/m², which equates to +1.6 bar. This is also a positive number, indicating that the KOH solution 103 is drawn into the porous layer 101 the attractive capillary action, but with a capillary pressure one-tenth that of the non-conductive layer 102.

Consider now a gas bubble of 0.1 μm radius forming in the open solution of the aqueous 6 M KOH 103.

The internal pressure needed for the gas bubble to support itself is inversely proportional to the diameter of the gas bubble, with the excess internal pressure ΔP, known as the Laplace pressure, given by the equation:

ΔP=2/R (2)

where is the surface tension (in units of: N/m) and R is the radius of the bubble (in units of: m).

Thus, in an open solution of aqueous 6 M KOH 103 at atmospheric pressure, a gas bubble with a radius of 0.1 μm (diameter=0.2 μm) will, according to equation (2), require an internal pressure of 1,496,000 N/m² (15.0 bar) above the external 1 bar pressure of the aqueous 6 M KOH. That equates to a total internal pressure within the bubble of 15.0+1=16.0 bar.

If, however, the above gas bubble were instead to form within the non conducting layer 102 having an average pore radius of 0.1 μm, then the gas bubble will, additionally, have to overcome the positive capillary pressure present in that layer, namely +15.6 bar. That is, the bubble will have to force the aqueous 6 M KOH solution out of the 0.1 μm pores and this will require an additional internal pressure above the pressure of the bulk electrolyte, to give a total internal pressure required of: 16.0+15.6=31.6 bar.

If the above gas bubble were, alternatively, to form within the conductive layer 101 having an average pore radius of 1 μm, then the gas bubble will only have to, additionally, overcome a positive capillary pressure of +1.6 bar. The total internal pressure required within a gas bubble of 0.1 μm radius will then be: 16.0+1.6=17.6 bar.

However, the electrode 100 can only form gas bubbles at locations within the electrode 101 which are both conductive and in fluid contact with water (a component of the aqueous electrolyte). That is, there are three possible locations at which gas/gas bubbles can be formed in electrode 101: (i) within the porous, conductive layer 101 itself, (ii) at the interface 105 between the porous, conductive layer 101 and the open solution of electrolyte 103, and (iii) at the interface 104 between the porous conductive layer 101 and the non conducting layer 102.

Gas bubbles of 0.1 μm radius at these various locations will need different internal pressures to hold them up. Within the conductive layer 101 itself, they would need an internal pressure of 17.6 bar. At the interface 105 between the porous conductive layer 101 and the open solution of electrolyte 103, they would need an internal pressure of 16 bar. At the interface 104 between the porous conductive layer 101 and the non conducting layer 102, they would need an internal pressure of 31.6 bar.

Accordingly, bubble formation at the interface 104 between the porous conductive layer 101 and the non conducting layer 102, would be highly disfavoured, requiring an internal pressure of at least 31.6 bar. They will be less disfavoured within the conducting layer 101 requiring an internal pressure of at least 17.6 bar. The bubble formation will be most favoured at the interface 105 between the porous conducting layer 101 and the open solution of electrolyte 103, requiring an internal pressure of only 16 bar or more.

That is, gas bubble formation in the electrode 100 would be directed to the rear electrode surface 105 (facing away from, and not a part of the inter-electrode space) by the effects of attractive capillary actions at all other locations at which gas or gas bubbles could be formed in the electrode. The attractive capillary actions tend to increase the internal pressure needed to push up a gas bubble and thereby hinder gas bubble formation at other locations.

### Capillary Pressures in Example Embodiment Gas Diffusion Electrodes

Consider now a gas diffusion electrode 110 comprising a liquid side layer 111, abutting a gas side layer 112, as depicted in FIG. 2(A). The electrode 110 is contacted on the liquid-facing side of the liquid side layer 111 by an open, liquid solution 113 (i.e. an aqueous electrolyte 113), which comprises aqueous 6 M KOH at a temperature of 60° C. and at an ambient pressure of atmospheric (1 bar). The liquid solution 113 is infused into and throughout the liquid side layer 111, up to its interface (115) with the gas side layer 112 The electrode 110 is contacted on the gas side of the gas side layer 112 by a gas 114 in a gas region which contains no liquid. The gas fills the gas side layer 112 up to its interface (115) with the liquid side layer 111. For example, in water electrolysis, where the electrolyte is water, gas 114 could be hydrogen gas or oxygen gas. The electrode 110 is therefore a gas diffusion electrode with a liquid-facing surface 116 and a gas-facing surface 117.

For the purposes of this example, the liquid side layer 111 will be considered to comprise a hydrophilic porous material having an average pore radius of 0.1 μm (average pore diameter=0.2 μm). If the contact angle of the electrolyte with the liquid side layer 111 is 5°, then the capillary pressure, P_{c}, can be calculated using equation (1) to be +1,562,213 N/m², which equates to +15.6 bar. The positive sign indicates that the KOH liquid solution 113 is drawn into the conductive, porous, hydrophilic, gas-permeable and liquid-permeable layer 111 by an attractive capillary action.

Consider now, by contrast, the case where the gas side layer 112 comprises a porous, gas-permeable and liquid-impermeable hydrophobic material (e.g. expanded PTFE, or ePTFE) having pores of average radius 0.1 μm (average diameter 0.2 μm), where the contact angle between the aqueous 6 M KOH solution (0.078409 N/m surface tension) and the hydrophobic material 112 is 115°. In this case, the capillary pressure, P_{c}, exerted on the aqueous 6 M KOH solution by the surface of the gas side layer will be −662,742 N/m², which equates to −6.6 bar.

Note that P_{c} is a negative number in this case, meaning that the KOH liquid solution 113 is repelled by (and gas/gas bubbles attracted to) the pores on the surface of the gas side layer 112. In other words, the gas side layer 112 exhibits a repulsive capillary action (with an accompanying negative capillary pressure). Another way to view such a capillary action is that gas/gas bubbles are hydrophobic and therefore attracted to and favoured to be drawn into the pores of the gas side layer 112.

Consider now the formation of a gas bubble of radius 0.1 μm. by the electrode 110. Gas bubbles are only formed at locations in the electrode 110 which are both conductive and in fluid contact with water. That is, the gas bubbles can form in three different possible locations within the electrode 110: (i) within the liquid side layer 111 itself, (ii) at the interface (116) of the liquid side layer 111 with the open solution 113, or (iii) at the interface (115) of the liquid side layer 111 with the gas side layer 112.

Within the liquid side layer 111 (average pore radius 0.1 μm), the internal pressure required to maintain a bubble of 0.1 μm radius would be higher by 15.6 bar since the bubble would have to displace liquid from the pores that is held there with a capillary pressure of +15.6 bar. That is, an internal pressure of 16.0+15.6=31.6 bar would be needed to maintain the bubble.

At the interface 115 between the liquid side layer 111 and the gas side layer 112, however, the internal pressure needed in the bubble would be decreased by 6.6 bar since the aqueous KOH solution is already partially displaced from the pores by the repulsive capillary action of those pores. That is, an internal pressure of only 16.0−6.6=9.4 bar would be needed.

At the interface 116 of the liquid side layer 111 with the open solution 113, there would be no capillary action assisting or hindering bubble formation, so that the internal pressure of the bubble would be 16 bar.

Thus, gas/gas bubble formation would be strongly favoured at the interface 115 between the liquid side layer 111 and the gas side layer 112. It would be favoured even relative to gas/gas bubble formation in open aqueous solution. That is, gas/gas bubble formation would be facilitated and accelerated at interface 115 relative to open solution.

In other words, whereas the use of an attractive capillary action at a location in an electrode acts to hinder and dissuade gas/gas bubble formation, the use of a repulsive capillary action acts to favour, facilitate and assist gas/gas bubble formation.

Electrodes with Efficient Gas Handling Properties

In examining how to make gas diffusion electrodes that are highly efficient at collecting and retaining gas, the inventors came to unexpectedly discover that repulsive capillary actions can be harnessed to this end. Such repulsive capillary actions can be utilized to selectively favour gas formation at particular locations in an electrode. Past porous electrode design has generally only directed gas bubble formation to particular locations by using attractive capillary actions to disfavour it elsewhere in the electrode.

That is, the inventors have discovered that rather than using attractive capillary actions (with associated positive capillary pressures) to disfavour gas formation at selected locations in a porous electrode as has previously been carried out, it is also possible and more desirable, to utilize repulsive capillary actions (with associated negative capillary pressures) to favour and direct gas formation at preferred locations in a gas diffusion electrode.

Another way to view the phenomenon of a repulsive capillary action is to consider that whereas liquid water will be repelled by and retreat from the walls of a hydrophobic capillary, gas/gas bubbles are hydrophobic and will therefore be attracted to and drawn up the walls of such a capillary. Thus, a porous hydrophobic surface displaying a repulsive capillary action towards a surrounding body of water, can be utilized to spontaneously draw gases into it. It can also hold gases within the surface (facilitate gas retention) due to the capillary action, which is attractive to gases (and repulsive to water).

The inventors have realised that certain porous hydrophobic, gas-permeable but liquid-impermeable materials, including but not limited to porous, gas-permeable and liquid-impermeable ePTFE substrates, display a repulsive capillary action with associated negative capillary pressure.

FIGS. 2A and 2B illustrate example embodiments of gas diffusion electrode structures with beneficial capillary pressure relationships. The electrode 110 of FIG. 2(A) comprises a liquid-side layer 111 made of a porous, gas-permeable, liquid-permeable, conductive, hydrophilic material and having a liquid-contacting side 116 contacting a liquid electrolyte 113. A catalyst material may be incorporated at one or more discrete regions of, or throughout the liquid-side layer 111 as will be described in further detail below.

The liquid-side layer 111 may be in contact with a gas-side layer 112 at a liquid-side/gas-side interface 115. The gas-side layer 112 may be made of a porous, non-conductive, gas-permeable and liquid-impermeable hydrophobic material. A gas-facing surface 117 of the gas-side layer 112 may be exposed to a free gas space 114. In some beneficial embodiments, the liquid side layer 111 may be configured to exhibit a significantly positive capillary pressure with the electrolyte 113, while the gas-side layer 112 may be configured to exhibit a significantly negative capillary pressure with the electrolyte 113.

In some embodiments, the liquid-gas interface 115 may be optimized to encourage desirable operation as described below. The nature and character of interface 115 may depend on multiple factors such as how the layers 111 and 112 are joined (e.g., pressure alone, heat lamination, solvent bonding, adhesive bonding, or combinations of these or other methods), the characteristics or composition of liquid electrolyte employed, and the nature and character of each of the materials making up the liquid-side layer 111 and the gas-side layer 112.

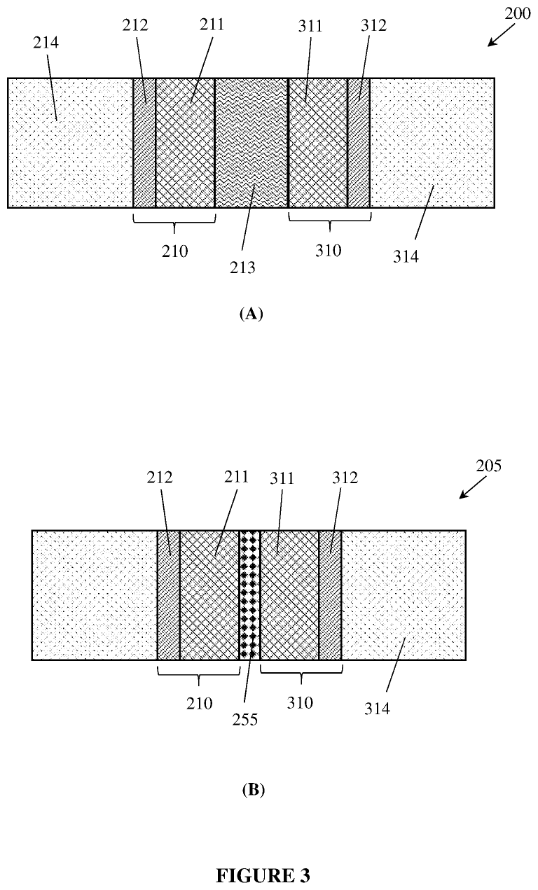

In a cell configuration, the liquid-side layer may be positioned adjacent to an inter-electrode space which may be adjacent to a counter-electrode as shown, for example, in FIG. 3. Therefore, the liquid-facing side 116 of the liquid-side layer 111 may also be referred to herein as the inter-electrode side 116 of the liquid-side layer 111.

The inventors have further discovered that, when incorporated within gas diffusion electrodes, the repulsive capillary actions of such materials have the effect of favouring or directing gas formation to their interface with an aqueous electrolyte. The extent to which gas formation is favoured and/or directed depends on the average pore diameter and pore distribution in the gas-side layer material, as well as its overall hydrophobicity. That is, the proportion of gas and the absolute volume of gas formed at a particular location in the electrode depends on the average pore diameter and pore distribution in the gas-side layer material, as well as its overall hydrophobicity.

Smaller and more regular pores having higher hydrophobicity may tend to favour and direct gas formation more strongly than larger, less regular pores having lower hydrophobicity. Accordingly, the inventors have realised that a useful approach to favour and direct gas formation to a desired surface or interface within an electrode, is to utilize a surface or interface comprising small and regular pores of high hydrophobicity. The repulsive capillary actions exerted by such surfaces or interfaces can be tailored to the application at hand. That is, the optimum and/or most practical pore diameter, regularity and hydrophobicity can be calculated/estimated in advance and applied initially, with subsequent iterative optimisation by empirical experiment. The inventors provide exemplar calculations in this respect in the specific examples that follow.

The inventors have further discovered that creating a cross-sectional gradient of capillary actions, from attractive to repulsive, in a gas diffusion electrode can be advantageously utilized to reliably collect and/or hold all of the gases generated or present. In this approach, a gas-side layer 112 may abut a plurality of liquid-side layers that are increasingly hydrophilic the further they are away from the liquid-gas interface 115.

Thus, a cross-sectional profile of attractive-to-repulsive capillary actions may be created. In the liquid-side layers, attractive capillary effects act to disfavour gas/gas bubble formation. That is, the attraction for water makes it more difficult for a newly-formed gas to push that water out of the way (eg when forming a gas bubble). The stronger the attractive capillary effect, the more difficult it is for gas formation to occur. At the gas-side layer surface 115 by contrast, repulsive capillary effects act to favour gas/gas bubble formation. That is, the repulsion of water by the surface makes it easier for newly-formed gas to push the water out of the way. Since gas will form preferentially where it is most favoured and least disfavoured, gas will form and collect first at the gas-side layer surface 115.

This approach allows for the most effective possible direction of gas formation to preferred locations in an electrode. Moreover, this approach allows for improved and accelerated gas production (since gas formation is favoured at the preferred, gas-side layer surface), with associated increases in gas volumes. The cross-sectional gradient of capillary actions may conform to a variety of profiles across a section of an electrode. For example, the change in the cross-sectional gradient of capillary effects could be stepped, linear, curved, asymmetric, asymptotic, or some other non-linear profile.

This approach also has the important advantage that gas formation in the outermost of the liquid-side layers will be exceedingly strongly disfavoured (since that layer will be the most hydrophilic and therefore have the strongest attractive capillary effect). That is, gas bubble formation will be most strongly disfavoured at the outermost portion of the liquid-side layer of the electrode, where it meets the aqueous electrolyte solution.

An alternative approach involves tailoring or varying the steepness of the cross-sectional gradient of capillary actions, from attractive to repulsive, by adjusting one or more factors such as the average diameter and/or distribution of the pores in the liquid-side layer(s), the hydrophilicity of the material in the liquid-side layer(s), the overall porosity of the liquid-side layers (that is, the volume fraction of the layer material within the liquid-side layer(s)), the thickness of the liquid-side layer(s), and/or incorporating hydrophobic strands, fibres or particulates, including porous, gas-permeable and liquid-impermeable hydrophobic strands, fibres or particulates, within the liquid-side layer(s).

Gas diffusion electrodes have been fabricated that collect and/or hold all of the gases generated or present in cells employing free liquid or gel electrolytes. During operation, these gas diffusion electrodes are totally, i.e. completely, free of observable gas bubbles on their liquid/gel-facing sides.

In one form, at least part of the electrode 110 may provide a repulsive capillary action for a liquid electrolyte 113. In operation, the liquid-side layer 111 may be wetted, or completely wetted, by the liquid electrolyte. The liquid-side layer 111 may be attached to or laminated to the gas-side layer 112. In another aspect, the electrode 110 may have a cross-sectional gradient of capillary actions, or the electrode 110 may include regions of different capillary actions.

In operation, a produced gas is preferentially formed at or directed to near the interface 115. The produced gas is then preferentially drawn into the gas-side layer 112 to join the gas 114 on the gas side of the electrode. For example, the produced gas is drawn into the gas-side layer 112 as a result of a repulsive capillary action for the liquid electrolyte 113 by at least part of the electrode 110. In one example, the liquid electrolyte 113 is water or water-based.

In another example, there is an attractive capillary action in the liquid-side layer 111; and there is a repulsive capillary action in the gas-side layer 112. In some embodiments, no bubbles of gas are formed during operation of the electrode 110.

In one example, an overpressure can be applied on the liquid electrolyte side relative to the gas side of the electrode 110, or an underpres sure can be applied to the gas side of the electrode 110 relative to the liquid side. The liquid-side layer 111 may be configured to be electro-active when wetted.

In various forms, the liquid-side layer may be conductive, porous, hydrophilic, gas-permeable and liquid-permeable 111 and include: conducting nanoparticles; conducting microparticles; and/or fibrillating particles of polytetrafluoroethylene. In operation, a repulsive capillary action toward the liquid electrolyte 113 can be created at or near the interface 115 by hydrophobic pores in the layer 112. A catalyst may be included in the liquid-side layer 111. In some embodiments, the catalyst may include Raney Ni and/or NiCo₂O₄ spinel.

In other examples, a catalyst may include one or more metals and/or an metal oxides, such as metals from the platinum group (platinum, ruthenium, rhodium, palladium, osmium, iridium), other noble metals (copper, silver, gold, mercury rhenium), nano-structured catalyst materials, nickel-iron compounds, or other catalyst materials or combinations of materials known for catalyzing desired reactions in an electrochemical cell.

In further examples, the catalysts may include: (i) Precious metal-based catalysts including but not limited to: 20% Pt—Pd on Vulcan XC-72, 10% Pt on Vulcan XC-72, 20% Pt—Ru on Vulcan XC-72, 20% Pt-Ir on Vulcan XC-72, 20% Pt—Co on Vulcan XC-72, 20% Pt—Ni on Vulcan XC-72, IrO₂, (ii) Perovskite catalysts including but not limited to: LaMnO₃, La_{0.8}Sr_{0.2}MnO₃, LaCoO₃ type perovskites, La_{0.7}Ca_{0.3}Ca_{0.3}, LaNiO₃ type perovskites; LaNi_{0.6}Fe_{0.4}O₃ (B site substituted by Fe), Ba_{0.5}Sr_{0.5}Co_{0.2}Fe_{0.8}O₃, LaNi_{0.6}Fe_{0.4}O₃, (iii) spinel catalysts including but not limited to: NiCo₂O₄, Mn_{1.5}Co_{1.5}O₄, Co₃O₄, NiFe₂O₄, Co_{0.5}Ni_{0.5}Fe₂O₄.

FIG. 2(B) illustrates an example electrochemical cell electrode 150 comprising a “bubble-suppression layer” 155 in addition to the liquid-side layer 111 and the gas-side layer 112 of the electrode 110 of FIG. 2(A). In various embodiments, the bubble-suppression layer 155 may be predominantly or entirely made of a non-conducting, porous material having uniformly small and hydrophilic pores that exhibit a particularly strong, attractive capillary action for water uptake.

The bubble-suppression layer 155 may be attached, adhered or otherwise secured to the inter-electrode facing side of the liquid-side layer as described below. The positive capillary pressure of the bubble-suppression layer 155 may make the formation of gas or gas bubbles at the surface of the inter-electrode facing side of the liquid-side layer much more difficult. For example, gas or gas bubble formation in the bubble-suppression layer 155 may be much more difficult than in the liquid-side layer 111. Moreover, the bubble suppression layer is not itself electrically conducting and is therefore not capable of generating gases. It acts merely to make bubble formation much more difficult on the surface of the inter-electrode facing side of the liquid side layer while allowing ions to diffuse between the electrodes. As a result, the application of the bubble-suppression layer to the inter-electrode facing side of the liquid-side layer may entirely block the formation of gas bubbles on the liquid side (i.e., the inter-electrode side) of the electrode.

In various examples, the capillary action varies from attractive to repulsive across the electrode 110 due to: variations in the average diameter of pores in the layer 111, hydrophilicity of a material in the layer 111, porosity of the layer 111, thickness of the layer 111, and/or inclusion of hydrophobic strands, fibres or particulates within the layer 111.

In another example, the liquid-side layer 111 may have a contact angle with the liquid electrolyte 113 that is less than a contact angle with the liquid electrolyte 113 for the gas-side layer 112.

In various embodiments, a gas-side layer may be made of commercially available materials or modified materials exhibiting desired properties. For example, in some embodiments, a gas-side layer material may be chosen on the basis of the pore size and hydrophobicity of the material.

For example, expanded polytetrafluoroethylene (ePTFE) membranes are strongly hydrophobic porous materials that may serve as gas side layers that generate a repulsive capillary action. Such membranes are manufactured commercially in numerous variants, each with a different average pore size and, in some cases, different hydrophobicities. Setting the capillary pressures and/or gradient of capillary pressures in an electrode may be achieved by merely selecting a commercially available ePTFE membrane with suitable pore sizes and hydrophobicity and using it as a gas-side layer in the electrode.

Other materials that may be suitable as a gas side layer include but are not limited to Mitex, Goretex, porous PVDF, porous polypropylene, porous polyethylene, porous Kynar, porous Hylar, porous polysulfones, porous polyethylsulfones, porous glasses, porous polyesters, fluoropore, Telsep, Polysep, Durapore, Biotrace, Fluorotrace, porous nylons, and porous fluoropolymers. Although ePTFE materials are referred to in various examples herein, any of the above materials may be substituted for the ePTFE membrane in any embodiment described or suggested herein.

In another embodiment, materials suitable to act as a gas side layer or a liquid side layer may be fabricated by modifying commercially available materials. That is, the pore size and/or hydrophobicity/hydrophilicity of an existing, commercially-available material may be altered by treating the material in a particular way.

For example, expanded PTFE (ePTFE) membranes may not be commercially available with pores of a desired average size, or with a particular, desired hydrophobicity. In that case, it is possible to select an ePTFE membrane with a close average pore size and/or hydrophobicity and then treat that membrane to thereby achieve the required properties. The treatment may involve coating the ePTFE with another material (e.g., a different polymer material) to thereby decrease the pore size or alter the hydrophobicity. Numerous coating methods in respect of membrane treatment are known to the art.

In some embodiments, a first layer of ePTFE with a first hydrophobicity, pore distribution, and/or pore size may be laminated, adhered, or otherwise combined with a second layer of ePTFE material with a different hydrophobicity, pore distribution, and/or pore size. Additional ePTFE layers with different pore sizes, pore distributions, or hydrophobicities may also be layered onto the first two. In this way, a multi-layered ePTFE structure may be formed to have a desired gradient of pore size, pore distribution, and/or hydrophobicity from one face to the other.

For example, a gas-side layer 112 may be configured from multiple layers of ePTFE to have a lower hydrophobicity, a larger pore size, and/or a more sparse pore distribution at a face adjacent to the gas-liquid interface 115 and a higher hydrophobicity, a smaller pore size, and a less-sparse pore distribution at a face 117 adjacent to the gas space 114.

In other embodiments, materials suitable to act as a gas side layer may be custom manufactured to obtain a desired pore size, pore distribution, and/or hydrophobicity.

In various embodiments, a liquid-side layer may be made of commercially available materials and/or modified materials exhibiting desired properties. For example, in some embodiments, a liquid-side layer material may be chosen and/or produced on the basis of the pore size, pore distribution, and/or and hydrophilicity of the material.

In some embodiments, a conductive liquid-side layer need only be at least partially conductive. Thus, in some embodiments only part of the conductive liquid-side layer is conductive. In some embodiments, a conductivity of a liquid-side layer can change depending on whether the liquid-side layer is dry or wetted with electrolyte.

In some embodiments, a liquid-side layer may comprise a current-collecting substrate carrying a catalyst material wherein the combined structure has a desired pore size, pore distribution, and/or hydrophilicity suitable to exhibit a desired capillary pressure in an electrolyte.

A current collecting substrate may comprise a porous conductive substrate such as a woven metal mesh, a non-woven metal mesh, a perforated metal foil, a perforated metal sheet, a metal foam, a non-woven fibrous metal felt or other porous metal structure capable of carrying a catalyst. In various embodiments, a metal current collecting substrate may be made of one or more metals such as nickel, copper, titanium, tin, zinc, or alloys or compounds of these or any other metals. In other embodiments, a current collecting substrate may comprise a carbon felt, a graphite felt, carbon nanotubes, a sintered porous carbon or graphite substrate, a woven or non-woven graphite mesh, or other porous conductive substrate structure capable of carrying a catalyst.

In various embodiments, the catalyst may be applied to the substrate by any suitable method, such as sputtering, electrodeposition, spraying, painting, inkjet printing or other additive manufacturing techniques, screen printing methods, lithography, compression, doctor blading, extrusion, or wet paste application. Some example processes are described in further detail below.

In some embodiments, a liquid side layer may be made and combined with a gas-side layer and/or a bubble-separation layer so as to produce a combined structure in which fibrillated particles of the liquid-side layer extend into and entangle structures of the gas-side layer and/or bubble-suppression layer material. As described in various examples below, the fibrillated particles may be formed at the time of creating the liquid-side layer, at a time of combining the liquid-side layer with a gas-side layer, at a time of combining the liquid-side layer with a bubble-suppression layer, or two or more of these.

Fibrillation is the process by which PTFE polymer chains unravel from each other and re-agglomerate into fine fibrils during shearing. Descriptions of fibrillation can be found in multiple scientific articles, including, for example, in an article entitled “Paste Extrusion of Polytetrafluoroethylene (PTFE) Fine Powder Resins” by Savvas G. Hatzikiriakos, Alfonsius B. Ariawan, and Sina Ebnesajjad in the Canadian Journal of Chemical Engineering, Volume 80, Issue 6, December 2002, Pages 1153-1165.

In some embodiments, the fibrillated particles may be fibrillated PTFE particles. The fibrillated PTFE within a liquid-side layer may create a fine network or interconnected web of PTFE fibrils within the liquid-side layer that may serve multiple beneficial functions. For example, the fibrillated PTFE network may help determine the contact angle of the overall liquid-side layer, it may help establish the average size and uniformity of the pore system within the liquid-side layer, and it may retain the integrity and cohesiveness of the liquid-side layer to thereby maintain the pore structure and contact angle.

In some embodiments, in place of a substrate material, a liquid-side layer may comprise particles of a conductive material such as carbon, graphite, or one or more metals, including those discussed above. Such conductive particles may be distributed throughout the liquid side layer to form a conductive network for conducting electrons to between catalyst particles and a voltage source or load.

In some embodiments, a liquid-side layer may comprise fibrillated PTFE strands entangling structures (e.g., fibers, strands, particles, or other structures) of a current-collecting substrate. In some embodiments, a liquid-side layer may comprise fibrillated PTFE strands distributed throughout the thickness of the liquid-side layer, including fibrillated PTFE strands extending into or through a current collecting substrate or distributed among conductive particles, and including some fibrillated PTFE strands extending partially into and entangling structures of the gas-side layer (e.g., an ePTFE membrane material in some embodiments), and/or a bubble-separation layer (e.g., a PES membrane material in some embodiments).

In some embodiments, a liquid-side layer may comprise fibrillated PTFE non-uniformly distributed throughout its thickness with a higher density of fibrillated PTFE strands adjacent its interfaces with both a gas-side layer and a bubble-suppression layer, while having a higher density of non-fibrillated PTFE particles at a central region of the liquid-side layer. In other embodiments, a liquid-side layer may comprise fibrillated PTFE strands predominantly only in regions at which the liquid-side layer interfaces with an adjacent layer such as a gas-side layer or a bubble-suppression layer.

In some embodiments, a liquid-side layer may have a varying density of fibrillated PTFE throughout its thickness. For example, a liquid-side layer may comprise a higher density of fibrillated PTFE strands adjacent its interface with a gas-side layer and a higher density of non-fibrillated PTFE particles at a region adjacent to a bubble-suppression layer or an inter-electrode space. In another embodiment, a liquid-side layer may comprise a higher density of fibrillated PTFE strands adjacent its interface with a bubble-suppression layer and a higher density of non-fibrillated PTFE particles at a region adjacent to a gas-side layer.

In some embodiments, a liquid-side layer may be secured to a gas-side layer and/or a bubble-suppression layer predominantly only by fibrillated PTFE (or other fibrillated binder materials) extending into and mechanically surrounding structures of a gas-side layer and/or bubble-suppression layer. In other embodiments, a liquid-side layer may be secured to a gas-side layer and/or a bubble-suppression layer by other methods or mechanisms in place of or in addition to fibrillated PTFE.

For example, layers may be attached by gluing or spot gluing in selected locations, hot-laminating, wet-laminating, face welding, surface welding, or edge welding, solvent bonding, or other methods. In some embodiments, some layers may merely be held tightly against each other by compression of the various layers.

In some embodiments, a bubble-suppression layer 155 may be made of a non-conducting, small-pored, hydrophilic material or a material that has been made hydrophilic by coating, including but not limited to: polyethersulfone, polysulfone, nylon, glass, amides and acrylamides, acrylates, ethylene glycols/oxides, polyvinyl alcohols, polyethers, maleic anhydride polymers, cellulose ester/acetate/nitrate polymers, hydrophilic polycarbonates, hydrophobic polyolefins, hydrophobic polytetrafluoroethylene, hydrophilic PVDF, and the like.

In some embodiments, a bubble-suppression layer 155 may be an un-modified polyethersulfone material, that is a polyethersulfone matrix that has not been modified by the addition of additives such as ZrO₂ or other materials. For example, the bubble-suppression layer may be a hydrophilic polyethersulfone membrane used in the filtration industry having the trade name Supor (supplied by Pall Corporation). Other tradenames and suppliers of hydrophilic membranes/porous materials that may serve as bubble-suppression layers include but are not limited to: Nucleopore (GE/Whatman), Omnipore (Millipore Sigma), Durapore (Millipore Sigma), Fluorpore (Millipore Sigma), Magnaprobe (GVS), Isopore (Millipore Sigma), Magna (GVS), Sterivex (Millipore Sigma), Cyclopore (GE/Whatman), Poretics (GVS), Nylaflow (Pall), PCTE (GVS), Anopore (GE), Puradisc (GE), Reliadisc (Ahlstrom), and Biotrans (MP Biomedical).

In various embodiments, a bubble-suppression layer may have a thickness of about 0.05 mm or less up to about 2 mm or more. in various examples and embodiments described herein, the bubble-suppression layer thickness may be chosen based on a desired total spacing between positive and negative electrodes.

### Example Electrode Structures

Example porous electrodes have been made and tested and will be described with continued reference to FIGS. 2A and 2B. The electrodes comprised a gas side layer 112 made of a commercially available expanded PTFE (ePTFE) membrane (product code QL217, provided by GE Energy). The gas-side layer ePTFE membrane was unmodified and had an average pore radius of 0.1 μm and a capillary pressure of −6.6 bar in 6 M KOH electrolyte at 60° C. (KOH surface tension 0.0780495 N/m; contact angle with ePTFE 115°).

For the liquid side layer 111, mixtures of Ni nanoparticle catalysts (ca. 20 nm average particle size; supplied by Skyspring Nanotechnology) and 10-50% by weight of PTFE fine powder (product code 65AX supplied by DuPont and maintained below 4° C. to avoid premature fibrillation) were combined with a 1:1 mixture of isopropanol and water. The mixture was prepared and applied with shearing via knife-coating (doctor blading) onto the ePTFE membrane. Small quantities of particulate carbon black (<1%) may also be included.

The conditions of manufacture of the liquid side layer involved slowly mixing the Ni nanoparticles and the PTFE fine powder, all the while actively maintaining the temperature of the mix below 4° C. (to avoid premature fibrillation of the PTFE). Once the mixing was complete and the mixture was homogeneous, the resulting slurry was applied by roll-to-roll coating using a knife deposition technique (typically with a 1.1-1.5 mm gap) to the PTFE membrane (passing below the knife coater at speeds of 0.15-5 m/min). The knife coating head was not actively cooled, although the cold coating solution which was constantly introduced may have kept it below room temperature.

In an alternative process, the PTFE membrane may be pre-coated with a basecoat containing the above PTFE fine powder only (optionally containing up to 10% particulate carbon black) and the above solvent mix, applied in the same way, using knife coating with the PTFE maintained at <4° C. until the point of coating. Immediately after being coated onto the moving ePTFE membrane, the still-wet coating may have a Ni mesh (110-200 LPI) embedded into it as part of a continuous roll-to-roll coating process.

In other embodiment processes, segments of a fine mesh may be hand-embedded into the wet coating produced by the above technique. The mesh segments may be finely woven Ni, (e.g., as supplied by Century Woven in Beijing, China). Very thin, conducting metal meshes from Precision eForming (Cortland, N.Y.) may also or alternatively be used. The entire assembly may then be passed through an 8 m long oven to be heated to 60° C., and then dried. Alternatively, segments of electrode may be allowed to air-dry.

Upon exiting the oven or after air-drying, the dried electrode may be passed through a compression roller to compress the liquid side layer. Such rollers may be set to a width of 0.1 mm plus the thickness of the mesh. Applied in this way, liquid side layers 111 were made that were 10-500 μm thick.

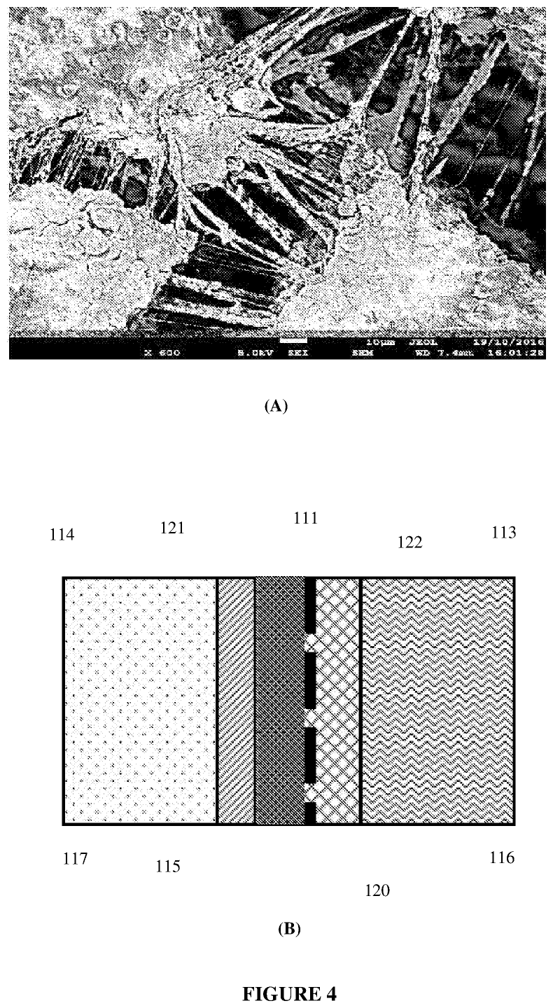

A scanning electron micrograph of a typical liquid side layer 111 made by the above technique is provided in FIG. 4(A). It revealed an inter-connected web network of hydrophobic PTFE fibrils, imparting layer 111 with a higher contact angle (due to the relative hydrophobicity of the PTFE fibrils) and an open-pored structure (likely >1 μm average; capillary pressure <+1.6 bar). The gradient of capillary pressures from interface 116 to interface 115 was therefore 6.6-8.2 bar. The porosity of the liquid side layer 111 fell in the range about 60-80%.

Scanning electron microscopy also revealed that fibrillation of the PTFE fine powder commenced upon knife coating and continued during the process of embedding the mesh, and then drying and compressing the electrode. The process of embedding the metal mesh into the wet coating was found to often result in a higher density of fibrillated PTFE forming below the mesh (between the mesh and the interface 115) than above the mesh (between the mesh and the interface 116). The resulting cross-sectional inhomogeneity of the PTFE component in the liquid side layer 111 led, in such cases, to a more distinct gradient of contact angles between interfaces 116 and 115 suggesting a distinct gradient of capillary pressures between the two surfaces. That is, the cross-section between the mesh and interface 116 was more hydrophilic than the cross-section between the mesh and interface 115, resulting in the latter having a less positive capillary pressure than the former.

FIG. 4(B) provides a schematic illustration depicting this feature in cross-section. A metal mesh 120 is shown embedded into the liquid side layer 111. In the illustrated embodiment, the liquid side layer 111 effectively comprises a first portion 121 between the mesh 120 and the interface 115 with the gas side layer and a second portion 122 between the mesh 120 and the interface 116 with the liquid electrolyte 113.

The process of embedding the mesh 120 into the liquid side layer 111 may occur while the PTFE component of the liquid side layer 111 is fibrillating. This may result in the first region 121 containing a higher weight proportion (or density) of fibrillated PTFE than the second portion 122. Accordingly, the second portion 122 may be more hydrophilic than the first portion 121, with an accompanying difference in capillary pressure. That is, the second portion 122 may have a larger, more positive capillary pressure than the first portion 121, thereby yielding a more distinct and sharper gradient of capillary pressures between interfaces 116 and 115. For example, if the liquid side layer 111 as a whole has a capillary pressure of +1.6 bar, then the second portion 122 may have a capillary pressure of +1.7 bar and the first portion 121 may have a capillary pressure of +1.5 bar.

By changing the conditions of the coating (e.g., a temperature, rate of shearing, speed of coating, knife height, or other factors as described in some embodiments below), it also proved possible to control in some measure, the relative proportions of fibrillated PTFE in portions 121 and 122 and to thereby modify the steepness and regularity of the capillary pressure gradient between interfaces 116 and 115. For example, the capillary pressure of region 122 may be made to vary between +1.7 bar to +2.0 bar, while the capillary pressure of region 121 may be made to vary between +1.5 bar and +1.0 bar.

Scanning electron microscopy also illuminated the nature of the interface 115 between the liquid side layer and the gas side layer. In cases where fibrillated PTFE was used, it was generally the case that fibrils were created that passed into and through the outermost portions of the porous structure of the ePTFE gas side layer 112, thereby entangling structures within the ePTFE layer. That is, the fibrils often mechanically interlocked with the microscopic fibrils of the ePTFE, thereby causing the liquid side layer to adhere to the gas side layer. In other words, the fine network of PTFE depicted in FIG. 4(A) often penetrated, intermingled with, and wrapped through and about the outermost reaches of the gas side layer 112.

To amplify and improve the fibrillation and the formation of the interconnected web of PTFE, it was also found that heat treatment of the liquid side layer 111 after drying, acted to draw the PTFE fibrils together. In the process, the entire liquid side layer may become compressed, generating smaller pores and higher capillary pressures. For example, heat treatment of liquid side layers was typically carried out at 200° C. for times of 3 min-3 h. Under these conditions, the fibrillated PTFE “necked”, drawing the bed tighter together.

An example electrode 110 was tested as a hydrogen generating electrode in water electrolysis using 6 M KOH solution as the liquid electrolyte 113 at 70° C. At current densities of 50 mA/cm² with a thin liquid side layer (35 μm thick), the electrode displayed no observable gas bubbles on its interface 116 with the liquid electrolyte. This is consistent with the prediction shown in Table 5 below indicating that the maximum recommended liquid-side layer thickness would be 36 μm using 6 M KOH at 70° C. with a 1 bar capillary pressure differential between interfaces 116 and 115. As the electrode actually had a larger gradient of capillary pressures (6.6-8.2 bar), the liquid-side layer 111 could be thicker and perform similarly.

In some embodiments, a porous electrode may be configured to utilize, at a gas formation location in or on the porous electrode, a repulsive capillary action (and associated negative capillary pressure) for wetting by a liquid or gel electrolyte, e.g. a liquid aqueous electrolyte, to thereby favour and/or direct gas formation to the gas formation location in or on the porous electrode, where it is in fluid contact with the liquid or gel electrolyte.

For an aqueous electrolyte example, by utilizing a repulsive capillary action, water, within a water phase, will be repelled by and retreat from the walls of a hydrophobic material, for example polytetrafluoroethylene (PTFE) material. Gas and gas bubbles are hydrophobic within a water phase and will therefore be attracted to such a material. Moreover, newly-formed gas or gas bubbles will be more easily accommodated at such a material since the water that needs to be moved out of the way is already repelled and has retreated from the material.

In example embodiments, the more repulsive the capillary action (and the larger the associated capillary pressure) toward the liquid/gel electrolyte at the gas formation location, the greater the extent to which gas formation is favored and/or directed to the gas formation location.

In example embodiments, the repulsive capillary action (and associated negative capillary pressure) toward the liquid/gel electrolyte at the gas formation location, is created by hydrophobic pores on or in the porous electrode at the gas formation location.

In example embodiments, the smaller, more uniform, and/or more hydrophobic the pores on or in the porous electrode at the gas formation location, the more repulsive the capillary action (and the larger the associated capillary pressure) toward the liquid/gel electrolyte, and therefore the greater the extent to which gas formation is favoured and/or directed to the gas formation location. This is, counter-intuitively, the case even for very small pore sizes that normally impede and hinder gas transit through them, relative to larger pored analogues.

In example embodiments, the pore diameters at the gas formation location may be less than or equal to 500 μm. In other example embodiments, the pore diameters at the gas formation location are less than or equal to 250 μm, less than or equal to 100 μm, less than or equal to 50 μm, less than or equal to 10 μm, less than or equal to 5 μm, less than or equal to 1 μm, less than or equal to 0.5 μm, less than or equal to 0.1 μm less than or equal to 0.05 μm, less than or equal to 0.025 μm, less than or equal to 0.01 μm, or less than or equal to 0.001 μm.

In some embodiments, the pores at the gas formation location have a monomodal and narrow distribution of diameters.

In some embodiments, at least at the gas formation location, the porous electrode comprises one or more hydrophobic materials that are gas-permeable and liquid-impermeable. In example embodiments, at least at the gas formation location, the electrode comprises materials having a contact angle with water that is more than or equal to 90°. In other example embodiments, at least at the gas formation location, the electrode comprises materials having a contact angle with water that is more than or equal to 95°, more than or equal to 100°, more than or equal to 105°, more than or equal to 110°, more than or equal to 115°, more than or equal to 118°, more than or equal to 120°, more than or equal to 125°, or more than or equal to 130°.

In example embodiments, the capillary pressures of the bubble suppression layer, the liquid side layer and the gas side layer (surface) may fall in the ranges shown below. Any combinations of these ranges for each layer may be used provided only that the bubble suppression layer has a more positive capillary pressure than the liquid side layer. Preferably, the most positive available capillary pressure is used for the bubble suppression layer and the liquid side layer, whilst the most negative available capillary pressure is used for the gas side layer.

TABLE A
Example capillary pressure range relationships for
bubble-free multi-layer gas diffusion electrodes.

| | | Gas Side Layer |
|---|---|---|
| Bubble | Liquid | (Gas-Liquid |
| Suppression Layer | Side Layer | Interface Surface) |
| 1 bar to 2 bar | 0.1 bar to 1 bar | −0.1 bar to −1 bar |
| 2 bar to 3 bar | 1 bar to 2 bar | −1 bar to −2 bar |
| 3 bar to 4 bar | 2 bar to 3 bar | −2 bar to −3 bar |
| 4 bar to 5 bar | 3 bar to 4 bar | −3 bar to −4 bar |
| 5 bar to 7 bar | 4 bar to 5 bar | −4 bar to −5 bar |
| 7 bar to 9 bar | 5 bar to 7 bar | −5 bar to −7 bar |
| 9 bar to 11 bar | 7 bar to 9 bar | −7 bar to −9 bar |
| 11 bar to 14 bar | 9 bar to 11 bar | −9 bar to −11 bar |
| 14 bar to 20 bar | 11 bar to 14 bar | −11 bar to −20 bar |
| 20 bar to 30 bar | 14 bar to 20 bar | −20 bar to −30 bar |
| 30 bar to 60 bar | 20 bar to 30 bar | −30 bar to −60 bar |
| 60 bar to 500 bar | 30 bar to 60 bar | −60 bar to −500 bar |
| | 60 bar to 500 bar | |

In further example embodiments, the repulsive capillary action (and associated negative capillary pressure) toward the liquid/gel electrolyte is created by the presence of hierarchical structure on or in the porous electrode at the gas formation location. Hierarchical structure is defined as structure that contains more than one level of structural and dimensional resolution. A hierarchical structure may, for example, contain millimetre-sized structural elements that contain within them, distinct micron structures that, in turn, contain within them distinct nano-sized structural elements, and so on and so forth. That is, a hierarchy of structural elements, each of different physical dimensions is present. For example, the porous electrode may be superhydrophobic at particular discrete locations due to the presence of micro- or nanoscopically fine surface structures that may be considered to be hierarchical in character on or in the porous electrode at the gas formation location, surface or interface.

In example embodiments, the more hydrophobic the porous electrode (due to the complexity and tortuosity of the hierarchical structure) at the gas formation location, the more repulsive the capillary action toward the liquid/gel electrolyte, and therefore the greater the extent to which gas formation is favoured and/or directed to the gas formation location. This is, counter-intuitively, the case even for extremely complex and tortuous hierarchical structures that would normally be expected to impede and hinder gas transit, relative to smoother surfaced analogues.

In another aspect, there is provided a gas diffusion electrode that utilizes a cross-sectional gradient of attractive to repulsive capillary actions (with associated positive to negative capillary pressures), to thereby favour and/or direct gas formation to a location, surface or interface in or on the electrode, where the electrode is in fluid contact with the liquid or gel electrolyte.

In another aspect, there is provided a gas diffusion electrode that collects and/or holds all of the gases generated or present within its gas-facing side, the gas diffusion electrode utilizing a repulsive capillary action (with associated negative capillary pressure) on, at, or about its liquid-facing side, where it is in fluid contact with the liquid or gel electrolyte.

In another aspect, there is provided a gas diffusion electrode that collects and/or holds all of the gases generated or present within its gas-facing side, the gas diffusion electrode utilizing a cross-sectional gradient of attractive to repulsive capillary actions (with associated positive to negative capillary pressures) on, at, or about its liquid/gel-facing side, where it is in fluid contact with the liquid or gel electrolyte.

In another aspect, there is provided a gas diffusion electrode that utilizes a repulsive capillary action (with associated negative capillary pressure) on, at, or about its liquid-facing side, the gas diffusion electrode being coated on its liquid/gel-facing side with a liquid-side layer, to thereby favour and/or direct gas formation at/to the surface of its gas side layer, where it is in fluid contact with the liquid or gel electrolyte.

In another aspect, there is provided a gas diffusion electrode coated with a liquid-side layer on its liquid/gel-facing side, that utilizes a cross-sectional gradient of attractive to repulsive capillary actions (with associated positive to negative capillary pressures) to thereby favour and/or direct gas formation to/at the surface of its gas-side layer, where it is in fluid contact with the liquid or gel electrolyte.

In another aspect, there is provided a gas diffusion electrode, coated with a liquid-side layer on its liquid/gel-facing side, the electrode collecting or holding all of the gases generated or present in its gas-facing side, the electrode utilizing a repulsive capillary action (with associated negative capillary pressure) on, at, or about its liquid/gel-facing side, where it is in fluid contact with the liquid or gel electrolyte.

In another aspect, there is provided a gas diffusion electrode, coated with a liquid-side layer on its liquid/gel-facing side, that collects or holds all of the gases generated or present, within its gas-facing side, the gas diffusion electrode utilizing a cross-sectional gradient of attractive to repulsive capillary actions (with associated positive to negative capillary pressures) on, at or about its liquid/gel-facing side, where it is in fluid contact with the liquid or gel electrolyte.

In some embodiments, an overpressure is applied over the gas diffusion electrode such that the liquid/gel-facing side experiences a higher pressure than the gas-facing side. In example embodiments, the overpressure is less than or equal to 0.5 bar. In other example embodiments, the overpressure is less than or equal to 1 bar, less than or equal to 1.5 bar, less than or equal to 2 bar, less than or equal to 3 bar, less than or equal to 5 bar, or less than or equal to 10 bar.

In some embodiments, the liquid-side layer is electro-active and not electro-inactive. That is, in some embodiments, the liquid-side layer is electrically conductive and catalytically active.

In some embodiments, the liquid-side layer has small pores. In example embodiments, the pore diameters may be less than or equal to 500 μm. In other example embodiments, the pore diameters of the porous, permeable wetted layer are less than or equal to 250 μm, less than or equal to 100 μm, less than or equal to 50 μm, less than or equal to 10 μm, less than or equal to 5 μm, less than or equal to 1 μm, less than or equal to 0.5 μm, less than or equal to 0.1 μm less than or equal to 0.05 μm, less than or equal to 0.025 μm, less than or equal to 0.01 μm, or less than or equal to 0.001 μm.

In some embodiments, the liquid-side layer (aqueously wetted layer in use) has a thickness commensurate with providing a cross-sectional gradient of attractive to repulsive capillary actions (with associated positive to negative capillary pressures) within the electrode. In example embodiments, the conductive, porous, hydrophilic, gas-permeable and liquid-permeable layer may be more than or equal to 0.005 μm thick. In other example embodiments, the porous, permeable wetted layer is more than or equal to 0.01 μm thick, more than or equal to 0.05 μm thick, more than or equal to 0.1 μm thick, more than or equal to 0.5 μm thick, more than or equal to 1 μm thick, more than or equal to 5 μm thick, more than or equal to 10 μm thick, more than or equal to 25 μm thick, more than or equal to 50 μm thick, more than or equal to 100 μm thick, more than or equal to 250 μm thick, or more than or equal to 500 μm thick.

In some embodiments, the liquid-side layer has an overall porosity commensurate with providing a cross-sectional gradient of attractive to repulsive capillary actions (with associated positive to negative capillary pressures) within the electrode. The term ‘porosity’ is defined here as the volume fraction of solid material within the liquid-side layer when it is dry and unwetted. In example embodiments, the liquid-side layer may be less than or equal to 90% porous, less than or equal to 80% porous, less than or equal to 60% porous, less than or equal to 50% porous, less than or equal to 40% porous, less than or equal to 30% porous, less than or equal to 20% porous, less than or equal to 10% porous, less than or equal to 5% porous, or less than or equal to 1% porous.

In some embodiments, the liquid-side layer comprises hydrophilic materials. A hydrophilic material is defined as having a contact angle with water that is less than or equal to 90°. In example embodiments, the liquid-side layer materials have a contact angle with water that is less than or equal to 80°, less than or equal to 60°, less than or equal to 40°, less than or equal to 20°, less than or equal to 10°, less than or equal to 8°, less than or equal to 5°, less than or equal to 2°, or less than or equal to 1°.

In some embodiments, the liquid-side layer contains fibres, strands or particulates of hydrophobic materials. The fibres, strands or particulates may, in some cases, form nucleation points for assisted gas bubble formation and/or pathways for assisted transport of gas toward the zone of most repulsive capillary action. Alternatively, or additionally, the fibres, strands or particulates may help create a gradient of attractive to repulsive capillary actions within the electrode.

In example embodiments, the fibres, strands or particulates comprise fibrillations of poly(tetrafluoroethylene) (PTFE). Such fibrillations may be created in several ways known to the art, including when fine particles of PTFE are smeared together during deposition of the wetted layer. In other example embodiments, the fibres, strands or particulates comprise porous, gas-permeable and liquid-impermeable segments of PTFE that are added to, mixed into, or attached to the liquid-side layer prior to or following its deposition on the porous, gas-permeable and liquid-impermeable electrode.

### Example Cell Structures

FIG. 3(A) illustrates an example electrochemical cell 200 comprising a negative electrode 210 and a positive electrode 310. Notably, the cell 200 does not include any ion-permeable, liquid-impermeable diaphragm or ionomer membrane positioned between the negative electrode and the positive electrode as would normally be required in a cell of, for example, the proton-exchange membrane (PEM) water electrolyzer type. Instead of an ion-permeable, liquid-impermeable diaphragm or ionomer membrane, the cell 200 of FIG. 3(A) contains only a liquid or gel electrolyte 213 between the electrodes 210 and 310.

In some embodiments, the negative electrode 210 and the positive electrode 310 may be arranged so as to be spaced no more than 2 mm apart. In an example, the electrochemical cell is a zero-gap cell of the type described in the following section.

In various embodiments, the negative electrode 210 and positive electrode 310 could be made of the same, or different, materials and be provided with the same, or different, catalysts.

The negative electrode 210 is contacted on its liquid side layer 211 by a liquid solution 213 (i.e. an aqueous electrolyte which may be water). The liquid solution 213 may be infused into and throughout the liquid side layer 211. The electrode 210 is contacted on the gas side layer 212 by a gas 214 in a gas region which contains no liquid. For example, in water electrolysis, where the electrolyte 213 is water, gas 214 would be hydrogen gas.

Similarly, the positive electrode 310 is contacted on the liquid side layer 311 by the liquid solution 213. The liquid solution 213 may be infused into and throughout the liquid side layer 311. The electrode 310 is contacted on the gas side layer 312 by a gas 314 in a gas region which contains no liquid. For example, in water electrolysis, where the electrolyte 213 is water, gas 314 would be oxygen gas.

FIG. 3(B) illustrates another example electrochemical cell 205, comprising a negative electrode 210 and a positive electrode 310 sandwiched on either sides of a bubble-suppression layer 255. The bubble-suppression layer being a hydrophilic membrane may be infused with liquid electrolyte 213 between the negative electrode 210 and positive electrode 310. The liquid electrolyte may also infuse the liquid side layers 211 and 311.

In some embodiments, the bubble-suppression layer may comprise two or more layers of material sandwiched together. In some embodiments, total thickness of the bubble-suppression layer (or multiple layers) may place the electrodes 210 & 310 no more than 2 mm apart. In an example, the electrochemical cell 205 may be a zero-gap cell of the type described in the following section.

### Zero-Gap Electrochemical Cells

The ability to avoid gas bubbles on the entire liquid side of a gas diffusion electrode and instead direct gas formation to the interface with the gas side, opens new opportunities in cell architecture. In particular, in the absence of gas bubbles it becomes unnecessary to incorporate an ion-permeable, gas-impermeable diaphragm or ionomer membrane between the positive electrode and negative electrode, even in cells where gases are actively generated at one or both of the electrodes. Accordingly, it enables the creation of ‘zero-gap’ cells without ion-permeable, gas-impermeable diaphragms or ionomer membranes between the facing gas diffusion electrodes.

A zero-gap cell is defined here as a cell in which the negative electrode and positive electrode electrodes are located in a facing disposition less than 2 mm apart. In some embodiments, the negative electrode and positive electrode electrodes are sandwiched tight against opposite sides of an electrolyte-infused bubble suppression layer or layers with a total thickness of less than 2 mm. The bubble-suppression layer may be an assembly of bubble-suppression layers of the type described in the previous section. The negative electrode and positive electrode electrodes may be less than 1 mm apart, less than 0.5 mm apart, less than 0.2 mm apart, less than 0.1 mm apart, less than 0.075 mm apart, less than 0.05 mm apart, or less than 0.025 mm apart.

Normally it is impossible to have a zero-gap cell without an ion-permeable, gas-impermeable diaphragm or ionomer between two gas-generating gas diffusion electrodes because gas produced or present at the one electrode will cross-over to and interfere with the other electrode. For this reason, a gas-impermeable, ion-permeable barrier, such as an ionomer or diaphragm is usually required between such electrodes. However, by designing the gas diffusion electrodes to hold gas within or direct gas formation to, effectively, the gas side of the electrode, the incidence of gas crossover between electrodes is drastically reduced. For this reason, an inter-electrode ion-permeable, gas-impermeable diaphragm or ionomer may become redundant and may be dispensed with.

For example, existing commercial water electrolyzers have an ion-permeable, gas-impermeable diaphragm or ionomer between the negative cathode (generating hydrogen gas) and the positive anode (generating oxygen gas) electrodes. However, an example embodiment zero-gap cell comprising example embodiment electrodes sandwiched on opposite sides of, for example, a 0.14 mm thick bubble-suppression layer is capable of generating hydrogen of high purity at the cathode and oxygen of high purity at the anode without an ion-permeable, gas-impermeable diaphragm or ionomer between the electrodes. The bubble suppression layer, being non-conducting, prevents electrical shorting between the electrodes.

Because it has a higher positive capillary pressure than the liquid side layers sandwiched on either side of it, the bubble-suppression layer may also assist with the creation of gradients of capillary pressure directed away from the center of the cell (where the capillary pressure is highest) toward each of the respective gas sides of the gas diffusion electrodes. That is, the presence of the gas suppression layer between the electrodes may help direct gas formation in each of the adjacent electrodes to their respective gas sides. Accordingly, the entire cell may operate in a bubble-free manner. Water may simply be added slowly and continuously to the gas suppression layer during operation to replenish the water that is consumed during the water electrolysis process.

The inventors have therefore realised that gas diffusion electrodes that eliminate the formation or presence of gas bubbles on their liquid sides, can be used to successfully construct zero-gap cells where the gas diffusion electrodes are located exceedingly close to one another without the presence of an intervening diaphragm or ionomer membrane of any type. This can be done without the risk of gas crossover that would exist if conventional electrodes or gas diffusion electrodes were used.

Zero-gap cells of this type enjoy and, in fact, amplify the advantages of conventional zero-gap cells, whilst simultaneously overcoming their disadvantages.

For example, the small inter-electrode gap and absence of an electrically resistive structure between the electrodes in zero-gap cells of this type means that the ion conductance between the electrodes may be amplified beyond what is possible in conventional zero-gap cells, with an accompanying minimization of the electrical resistance/impedance. That is, example embodiment zero-gap cells may operate substantially more efficiently and with lower energy wastage than comparable, conventional zero-gap cells at the same applied voltage, using the same catalysts.

Moreover, the presence of an open liquid or gel electrolyte between the electrodes makes replenishment of consumed/unevenly-distributed electrolyte or conducting ions in the inter-electrode gap far simpler and more readily achieved. For example, an open liquid electrolyte between the electrodes, may be circulated around an external circuit and replenished/re-equilibrated during this process. A problem in conventional zero-gap cells is that ions and electrolyte may become unevenly distributed in the inter-electrode gap during operation. For example, a common phenomenon in Proton Exchange Membrane (PEM) fuel cells is water build-up on one side of the PEM membrane and water-depletion on the other side during operation.

A circulating liquid electrolyte may also be used for effective thermal management of the cell. That is, while circulating about an external circuit, the electrolyte can be cooled or heated at a separate location thereby controlling or managing the temperature of the zero-gap cell itself. In this way it is possible to eliminate the need to perform thermal management using the gases involved in the cell, as may be needed in conventional zero-gap cells. Several other advantages may also be realised.

In a further aspect there is therefore provided a zero-gap electrochemical cell in which two gas diffusion electrodes are located in close proximity to each other, facing each other in an approximately parallel disposition, with only a liquid electrolyte or a gel electrolyte between the electrodes. The electrodes are spaced less than 2 mm apart.

In another aspect there is provided a zero-gap electrochemical cell in which two gas diffusion electrodes are located facing each other in an approximately parallel disposition, with only a liquid-porous spacer (that can be liquid-infused), or a gel-porous spacer (that can be gel-infused), between the electrodes. The electrodes may be sandwiched tight against opposite sides of the liquid-porous spacer. The electrodes may be spaced less than 2 mm apart.

In example embodiments, one or both of the gas diffusion electrodes may utilize a repulsive capillary action (with associated negative capillary pressure) on, at, or about its liquid/gel-facing side, to thereby favour and/or direct gas formation to a location in or on the gas diffusion electrode, where it is in fluid contact with the liquid or gel electrolyte.

In another aspect there is provided an electrochemical cell comprising an electrolyte, a negative electrode in contact with the electrolyte, a liquid-side layer of the negative electrode providing an attractive capillary action to the electrolyte and a gas-side layer of the negative electrode providing a repulsive capillary action to the electrolyte, and a positive electrode in contact with the electrolyte, a liquid-side layer of the positive electrode providing an attractive capillary action to the electrolyte and a gas-side layer of the positive electrode providing a repulsive capillary action to the electrolyte.

In another aspect there is provided a method of operating an electrochemical cell, wherein the electrochemical cell comprises: an electrolyte; a negative electrode in contact with the electrolyte, a liquid-side layer of the negative electrode providing an attractive capillary action to the electrolyte and a gas-side layer of the negative electrode providing a repulsive capillary action to the electrolyte; and a positive electrode in contact with the electrolyte, a liquid-side layer of the positive electrode providing an attractive capillary action to the electrolyte and a gas-side layer of the positive electrode providing a repulsive capillary action to the electrolyte. The method comprising the steps of: wetting each liquid-side layer with the liquid electrolyte; forming a produced gas at or near an interface between the liquid-side layer of the negative electrode and the gas-side layer of the negative electrode; and forming a different produced gas at or near an interface between the liquid-side layer of the positive electrode and the gas-side layer of the positive electrode.

In some embodiments, each of the above repulsive capillary actions (and associated negative capillary pressures) is created by the hydrophobicity and/or porosity of the electrode at the relevant location.

In some embodiments, each of the above repulsive capillary actions (with associated negative capillary pressures) is created by the presence of small and regular pores of high hydrophobicity, which favour gas formation more strongly than larger, less regular pores having lower hydrophobicity, in or on the electrode at the relevant location.

In example embodiments, the smaller, more uniform, and/or more hydrophobic the pores at the relevant location on or in each porous electrode, the more repulsive the capillary action (and the stronger the associated capillary pressure) toward the liquid/gel electrolyte, and therefore the greater the extent to which gas formation is favoured and/or directed to the gas formation location. This is, counter-intuitively, the case even for very small pore sizes that impede and hinder gas transit through them, relative to larger pored analogues.

In further example embodiments, one or more of the above repulsive capillary actions (and associated negative capillary pressures) is created by the presence of hierarchical structure on or in the porous electrode. For example, one or both of the porous electrodes may be superhydrophobic at particular locations due to the presence of micro- or nanoscopically small surface structures that may be considered to be hierarchical in character.

In example embodiments, the more hydrophobic a porous electrode (due to the complexity and tortuosity of the hierarchical structure) at that location, the more repulsive the capillary action (and the larger the associated capillary pressure) toward the liquid/gel electrolyte, and therefore the greater the extent to which gas formation is favoured and/or directed to the gas formation location. This is, counter-intuitively, the case even for extremely complex and tortuous hierarchical structures that would normally be expected to impede and hinder gas transit, relative to smoother surfaced analogues.

In some embodiments, the liquid-side layers on one or both of the above electrodes contain fibres, strands or particulates of hydrophobic materials. The fibres, strands or particulates may, in some cases, form nucleation points for assisted gas bubble formation and/or pathways for assisted transport of gas toward the zone of most repulsive capillary action. Alternatively, or additionally, the fibres, strands or particulates may help create a gradient of attractive to repulsive capillary actions within the electrode.

In example embodiments, the fibres, strands or particulates comprise fibrillations of poly(tetrafluoroethylene) (PTFE). Such fibrillations may be created in several ways known to the art, including when fine particles of PTFE are smeared together during deposition of the wetted layer. In other example embodiments, the fibres, strands or particulates comprise porous, gas-permeable and liquid-impermeable segments of PTFE that are added to, mixed into, or attached to the wetted layer prior to or following its deposition on the porous, gas-permeable and liquid-impermeable electrode.

In example embodiments, one or both of the gas diffusion electrodes may utilize a cross-sectional gradient of attractive to repulsive capillary actions (with associated positive to negative capillary pressures) on, at, or about its liquid/gel-facing side to thereby favour and/or direct gas formation to a location in or on the gas diffusion electrode, where it is in fluid contact with the liquid or gel electrolyte.

In example embodiments, one or both of the gas diffusion electrodes may be configured to collect and/or hold all of the gases generated or present within its gas-facing side, the gas diffusion electrode utilizing a repulsive capillary action (with associated negative capillary pressure) on, at, or about its liquid/gel-facing side, where it is in fluid contact with the liquid or gel electrolyte.

In example embodiments, one or both of the gas diffusion electrodes, may be configured to collect and/or hold all of the gases generated or present within its gas-facing side, the gas diffusion electrode utilizing a cross-sectional gradient of attractive to repulsive capillary actions (with associated positive to negative capillary pressures) on, at, or about its liquid/gel-facing side, where it is in fluid contact with the liquid or gel electrolyte.

In example embodiments, one or both of the gas diffusion electrodes, may utilize a repulsive capillary action (with associated negative capillary pressure) on, at, or about its liquid-facing side, the gas diffusion electrode being coated on its liquid/gel-facing side with a liquid-side layer, to thereby favour and/or direct gas formation on or in its liquid/gel-facing side to a location where it is in fluid contact with the liquid or gel electrolyte.

In example embodiments, one or both of the gas diffusion electrodes, may be coated with a liquid-side layer that utilizes a cross-sectional gradient of attractive to repulsive capillary actions (with associated positive to negative capillary pressures) on, at, or about its liquid/gel-facing side, to thereby favour and/or direct gas formation on or in its liquid/gel-facing side to a location where it is in fluid contact with the liquid or gel electrolyte.

In example embodiments, one or both of the gas diffusion electrodes, may be coated with a liquid-side layer on its liquid-facing side, the electrode collecting or holding all of the gases generated or present within its gas-facing side, the gas diffusion electrode utilizing a repulsive capillary action (and associated negative capillary pressure) on, at, or about its liquid/gel-facing side, where it is in fluid contact with the liquid or gel electrolyte.

In example embodiments, one or both of the gas diffusion electrodes, may be coated with a liquid-side layer on its liquid/gel-facing side, the electrode collecting or holding all of the gases generated or present, within its gas-facing side, the electrode utilizing a cross-sectional gradient of attractive to repulsive capillary actions (with associated positive to negative capillary pressures) on, at or about its liquid/gel-facing side, where it is in fluid contact with the liquid or gel electrolyte.

In some embodiments, an overpressure is applied over the cell such that the liquid/gel-facing side(s) of the gas diffusion electrode(s) experience a higher pressure than the gas-facing side(s). In example embodiments, the overpressure is less than or equal to 0.5 bar. In other example embodiments, the overpressure is less than or equal to 1 bar, less than or equal to 1.5 bar, less than or equal to 2 bar, less than or equal to 3 bar, less than or equal to 5 bar, or less than or equal to 10 bar.

In some embodiments, when immersed in the liquid or gel electrolyte, each gas diffusion electrode in the zero-gap cell is free of observable gas bubbles where it is in fluid contact with the liquid or gel electrolyte.

In example embodiments, during operation the inter-electrode gap is free of bridging gas bubbles.

In example embodiments, during operation the inter-electrode gap is free of visible gas bubbles.

In example embodiments, during operation the inter-electrode gap is free of gas bubbles having a size of more than 100 μm. In example embodiments, during operation the inter-electrode gap is free of gas bubbles having a size of more than 50 μm, more than 40 μm, more than 30 μm, more than 20 μm, more than 10 μm, more than 5 μm, or more than 1 μm.

In another aspect there is provided a zero-gap gas-liquid electrochemical cell in which two gas diffusion electrodes are located in close proximity to each other, facing each other in an approximately parallel disposition, with only a liquid electrolyte or a gel electrolyte, or with only a liquid-infused, liquid-porous spacer or a gel-infused, gel-porous spacer, between them, and without a diaphragm or ionomer membrane present in the gap between the electrodes.

In another aspect there is provided a zero-gap gas-liquid electrochemical cell in which two gas diffusion electrodes are located in close proximity to each other, facing each other in an approximately parallel disposition, with only a liquid-infused liquid-porous spacer or a gel-infused gel-porous spacer, between the gas diffusion electrodes. In some embodiments, a zero-gap cell is characterised by a higher conductivity and lower resistance (relative to comparable, conventional zero gap cells) between the electrodes.

In another aspect there is provided a zero-gap cell in which two gas diffusion electrodes are located in close proximity to each other, facing each other in an approximately parallel disposition, with only a liquid electrolyte or a gel electrolyte, or with only a liquid-infused liquid-porous spacer or a gel-infused gel-porous spacer, between the gas diffusion electrodes, and without an ion-permeable, gas-impermeable diaphragm or ionomer membrane present in the gap between the electrodes. In some embodiments, the cell thereby achieves a higher conductivity and lower resistance between the electrodes than is possible with the presence of an ion-permeable, gas-impermeable diaphragm or ionomer membrane present in the gap between the electrodes.

In another aspect there is provided a zero-gap cell in which two gas diffusion electrodes are located in close proximity to each other, facing each other in an approximately parallel disposition, with only a liquid electrolyte or a gel electrolyte, or with only a liquid-infused liquid-porous spacer or a gel-infused gel-porous spacer, between the gas diffusion electrodes, the liquid/gel electrolyte being actively circulated through an external circuit that includes the inter-electrode gap.

In another aspect there is provided a zero-gap cell in which two gas diffusion electrodes are located in close proximity to each other, facing each other in an approximately parallel disposition, with only a liquid electrolyte or a gel electrolyte, or with only a liquid-infused liquid-porous spacer or a gel-infused gel-porous spacer, between the gas diffusion electrodes, the liquid/gel electrolyte being actively circulated through an external circuit that includes the inter-electrode gap, the circulating electrolyte being separately cooled or heated during its circulation so as to thereby manage the temperature and thermal performance of the cell.

In another aspect there is provided a zero-gap cell in which two gas diffusion electrodes are located in close proximity to each other, facing each other in an approximately parallel disposition, with only a liquid electrolyte or a gel electrolyte, or with only a liquid-infused liquid-porous spacer or a gel-infused gel-porous spacer, between the gas diffusion electrodes, the liquid/gel electrolyte being actively circulated through an external circuit that includes the inter-electrode gap, the circulating electrolyte having replenishment liquid and/or ions separately added to it during its circulation, to replace depleted liquid or ions.

In example embodiments, the proportion of gas crossover from one electrode to the other in the zero-gap cell, is less than or equal to 1%. In example embodiments, the proportion of gas crossover from one electrode to the other is less than or equal to 2%, less than or equal to 4%, less than or equal to 6%, less than or equal to 8%, less than or equal to 10%, less than or equal to 15%, less than or equal to 20%, less than or equal to 30%, or less than or equal to 40%.

In example embodiments, the zero-gap cell has no fine-pored structure between the electrodes.

In example embodiments, the zero-gap cell has no fine-pored structure between the electrodes, meaning that the ion conductance between the electrodes is greater than is possible in conventional zero-gap cells, with an accompanying minimisation of the electrical resistance.

Accordingly, there is provided an electrochemical cell for a gas-liquid transformation, the cell comprising: a liquid or gel electrolyte; at least one electrode, the electrode facilitating gas formation and collecting the formed gases, or accepting and holding the gases passed into the electrode through the combination of a gas side layer with a repulsive capillary action (with associated capillary pressure that is more negative than −0.1 bar), and/or a liquid side layer with an attractive capillary action (with associated capillary pressure that is more positive than +0.1 bar); wherein a cross-sectional gradient of attractive to repulsive capillary actions (with associated gradient of capillary pressures that is 1 bar or more).

A combination of one or more of the following may contribute to the capillary pressure and operation of the liquid side layer: the average diameter and distribution of the pores in the liquid-side layer; the hydrophilicity of the layer material in the liquid-side layer; the overall porosity of the liquid-side layer; the thickness of the liquid-side layer; the presence of hydrophobic strands, fibres, or particulates, including porous, gas-permeable and liquid-impermeable hydrophobic strands, fibres or particulates, within the liquid-side layer.

### Example Methods of Making Beneficial Electrode Structures and Cells

As described briefly above, several methods may be used for creating a liquid side layer and combining it with a gas-side layer and/or a bubble-separation layer to form a layered electrode and/or cell structure.

For example, in some embodiments, characteristics of the liquid-side layer 111 such as the contact angle and pore size may be established by constructing the liquid-side layer from a wet or dry mixture of nanoparticles and/or microparticles of one or more catalyst materials in addition to particles of PTFE that may be fibrillated. In some embodiments, the PTFE particles may be fibrillated during application of the mixture to a substrate or other material.

In one example wet paste application process, a paste mixture comprising catalyst particles, binder particles, and a solvent may be mixed to form a wet paste that may be applied to the substrate and/or to other layers of an electrode structure. In some embodiments, the binder particles may comprise PTFE (polytetrafluoroethylene) particles in a form allowing them to be fibrillated when subjected to shearing force prior to, during, or after application of the mixture to the substrate or other electrode structure.

In some embodiments, PTFE powder or particles may be transported and maintained at low temperatures (e.g., less than 5 degrees Celsius or lower) in order to maintain a non-fibrillated (e.g., spherical or amorphous) shape prior to application of a shear force at a desired time and location within the electrode structure. These and other steps may be taken to avoid undesired premature fibrillation of the PTFE particles.

The fibrillated PTFE fibres or strands may also beneficially form nucleation points for assisted gas bubble formation and/or pathways for assisted transmission of gas bubbles toward the zone of most negative capillary pressure within the electrode. Alternatively, or additionally, the fibres or strands may help create a more uniform gradient of attractive to repulsive capillary actions (positive to negative capillary pressures) within the electrode.

In some embodiments, a wet mixture may be made by combining a quantity of catalyst material particles (in a size and proportion selected based on a desired catalyst loading of a final electrode) with a quantity of fibrillatable PTFE particles (in a size, quantity, and condition selected for forming fibrillated strands of a desired size and quantity) with a surfactant or other wetting agent. The surfactant may be used for creating surface tension between the mixture particles sufficient to maintain the mixture in a paste-like form. In various embodiments, the surfactant may comprise water, a liquid electrolyte, an alcohol, or other wetting liquid.

For example, in some embodiments, a wet or dry mixture may be applied to a conductive substrate material with a scraper such as a doctor blade (aka “ductor blade,” “knife coater,” or “knife deposition”). The doctor blade may be configured to apply a consistent-thickness of the mixture to the substrate while applying a shear force to the mixture relative to the substrate. Such shearing may cause the PTFE particles in the mixture at the interface with the substrate to fibrillate. Some of the fibrillated PTFE may become entangled with fibers, strands, or structures in the substrate material, creating a mechanical attachment between the applied mixture and the substrate. In some embodiments, the conductive substrate may be moved relative to the doctor blade in a roll-to-roll or other automated processing system.

In alternate embodiments, substantially the same doctor blade application process may be used to apply a similar wet or dry mixture to a bubble-suppression layer material, creating fibrillated PTFE strands that may similarly entangle the bubble-suppression layer. In some embodiments, a current collecting substrate may then be pressed into the mixture coated onto the bubble-suppression layer. In some embodiments, after pressing a current collecting substrate into a mixture coated onto a bubble-suppression layer membrane, a gas-side layer membrane may be pressed into a portion of the mixture extending through the substrate.

In some embodiments, an electrochemical cell may be formed by applying a first liquid-side layer to a first side of a bubble-suppression layer, applying a first gas-side layer to the first liquid-side layer, applying a second liquid-side layer to a second side of the bubble-suppression layer opposite the first side of the bubble-suppression layer, and applying a second gas-side layer to the second liquid-side layer. Thereby, an electrochemical cell is formed that has only one layer of bubble-suppression layer membrane between the first and second electrodes. In other embodiments, electrochemical cells may be formed with a separate layer of bubble-suppression layer for each electrode, and the bubble-suppression layers may be pressed against one another or fused together.

In further embodiments, substantially the same doctor blade application process may be used to apply a wet or dry mixture to a gas-side layer material (e.g., an ePTFE membrane in some embodiments), creating fibrillated PTFE strands that may similarly entangle the gas-side layer. In some embodiments, a current collecting substrate may then be pressed into the mixture coated onto the gas-side layer.

In still other embodiments, after pressing a current collecting substrate into a mixture coated onto a gas-side layer membrane, a bubble-suppression layer may be pressed into a portion of the mixture extending through the substrate.

In any of the foregoing embodiments, a current-collecting substrate may be omitted and/or replaced with a particulate, fibrous, or amorphous conductive additive distributed throughout the mixture.

In some embodiments, a wet or dry mixture of catalyst and fibrillatable PTFE particles may be treated so as to produce fibrillated PTFE particles prior to coating the mixture onto a gas-side layer, bubble-suppression layer, or current collecting substrate as described above.

In still other embodiments, methods other than doctor blade processes may be used to apply the mixture onto a gas-side layer, bubble-suppression layer, and/or current collecting substrate. For example, in some embodiments a wet mixture may be sprayed, painted, printed, injected, extruded, or otherwise applied.

### Operating Electrochemical Cells With Beneficial Electrodes

The inventors have further recognised that a capacity to avoid the formation of gas bubbles at gas diffusion electrodes and within electrochemical cells, can be used to (profoundly) alter the thermodynamics and/or kinetics of gas-to-liquid or liquid-to-gas transformations. Such transformations are often dominated by the thermodynamics and/or kinetics of bubble formation and/or release/uptake. Without bubbles, the intrinsic, underlying thermodynamics and kinetics of such transformations may instead be achieved. This is commonly far more favourable than it is with bubbles.

A case in point is water electrolysis, which involves the generation, from water, of hydrogen gas at the negative electrode and oxygen gas at the positive electrode.

In conventional electrolyzers, bubbles of hydrogen are generated at the negative electrode and bubbles of oxygen at the positive electrode. These bubbles must be kept apart, which is typically achieved by the use of an ion-permeable, gas-impermeable diaphragm or ionomer membrane between the electrodes. Current vs Voltage plots of such water electrolyzers (known as ‘Polarisation Curves’) show that they need an excess voltage (known as the activation overpotential, ^{act}_{cell}) to get the water-splitting process started. Thereafter, the current increases linearly with voltage. The voltage at which this commences is known as the ‘onset voltage’. In the very best conventional water electrolyzers, the onset voltage is typically around 1.40 V at 80° C., which equates to an ^{act}_{cell} of 0.22 V. That is, an additional voltage of 0.22 V above the thermodynamic minimum is needed to get the electrolytic process started. The current at which activation is complete is typically >100 mA/cm², meaning that the polarisation curve shows a distinct and very characteristic dogleg in its initial stages (known as the ‘activation dogleg’). It flattens out to linearity at currents above about 100 mA/cm².

By contrast, using the above techniques, example embodiment gas diffusion electrodes can be engineered in which a large net capillary action for gas uptake is present. In such electrodes, the net differential capillary pressure vigorously extracts the gases from the liquid-side layer into the gas-side layer of the electrode immediately upon their formation and without the intermediacy of bubble formation. In so doing, the energy penalties and kinetic limitations arising from bubble formation are avoided. The effect on the thermodynamics of water-splitting is dramatic and profoundly fundamental.

Firstly, as described herein, an example embodiment cell with example embodiment gas diffusion electrodes having a net differential capillary pressure for gas uptake of about 6.3 bar, produced an onset voltage of 1.27 V at 80° C., which equates to an ^{act}_{cell} of 0.09 V. That is, a far smaller additional voltage above the thermodynamic minimum was needed to get the electrolytic process started. Moreover, the current at which activation was complete was 20 mA/cm², meaning that the polarisation curve was, effectively, almost linear and did not display an ‘activation dogleg’. In fact, the polarisation curve passed just above the thermodynamic minimum voltage for water electrolysis. Polarization curves that are linear or near-linear and that pass close to the thermodynamic minimum voltage have only been observed in “steam electrolyzers”, such as solid oxide water electrolyzers that rely on high operating temperatures to achieve their efficiency (e.g. 700-900° C. for solid oxide electrolyzers).

Thus, it can be clearly seen that the example embodiment electrolyzer created. fundamentally different (improved) thermodynamics and kinetics relative to conventional, bubbled electrolyzers. They conformed to the underlying properties of the liquid-to-gas transformation, whereas in conventional electrolyzers, they are distorted by the properties of bubble formation and release.

One effect of this change is that, as described below, example embodiment water electrolysers could be fabricated that were capable of splitting seawater into exclusively oxygen gas at the positive electrode, with no chlorine gas formed. That is, example embodiment water electrolyzer cells could be developed that employed a seawater electrolyte, where the positive electrode produced only oxygen gas and no chlorine gas.

Conventional electrolyzers filled with seawater generate only chlorine gas at the positive electrode. This is because, in the presence of salt, chlorine has a lower overpotential for bubble formation than oxygen. Whereas oxygen formation is, in theory, thermodynamically more favourable than chlorine formation, chlorine is instead formed because the energy penalty and kinetics of doing so in a bubbled system is lower than it is for oxygen formation.

By contrast, example embodiment electrolyzer cells have been developed that generate oxygen gas, in bulk quantities, at cell voltages as low as 1.24-1.26 V at 80° C. These cell voltages are above the minimum thermodynamic voltage for water oxidation at 80° C. (1.18 V) but below the minimum thermodynamic voltage for chlorine formation (1.29 V). To the best of the inventors' knowledge, no abiological catalyst has thus far been shown to be capable of generating O₂ from pH-unmodified seawater at a voltage below the thermodynamic minimum for Cl₂ formation. The example embodiment cell therefore changed the nature and character of the liquid-to-gas transformation.

Accordingly, there is provided a method for engineering a cell that modifies the thermodynamics and/or the kinetics of liquid-to-gas or gas-to-liquid transformations, the method comprising the steps of: (1) Fabricating or selecting suitable gas-side layers for a gas diffusion positive electrode and/or a gas diffusion negative electrode. The gas-side layers may have pre-specified (repulsive) negative capillary pressures; (2) Fabricating or selecting one or more suitable liquid-side layers for a gas diffusion positive electrode and/or a gas diffusion negative electrode. The liquid-side layers may have pre-specified (attractive) positive capillary pressures. Optionally, a bubble-suppression layer may be included as an outermost layer. The bubble-suppression layer may have a pre-specified (attractive) positive capillary pressure; (3) Fabricating a gas diffusion positive electrode and/or a gas diffusion negative electrode by fusing, merging, abutting or co-locating appropriate gas-side layers adjacent to liquid-side layer(s) and bubble-suppression layers using methods known to the art. The resulting gas diffusion positive electrode and negative electrode may have pre-specified gradients of attractive to repulsive capillary pressures, with net capillary pressures. The net capillary pressure differential in each electrode may be such that newly formed gases in the liquid-side layer(s) are favoured to be extracted directly into the gas-side layer immediately upon their formation; (4) Fabricating a cell containing at least one of the above gas diffusion positive electrode or gas diffusion negative electrode. The cell may be a zero-gap cell; (5) Applying the cell to a liquid-to-gas or gas-to-liquid transformation.

The cell design may be such that the cell modifies the thermodynamics of the gas-to-liquid transformation as observed in a conventional (bubbled) cell. The cell design may be such that the cell eliminates or reduces thermodynamic and/or kinetic limitations arising from bubble formation and/or release/uptake. The cell design may be such that the cell conforms to the thermodynamics and/or kinetics of the underlying electrochemical transformation.

In another aspect, the method is used to engineer a water electrolyzer that uses seawater electrolyte to generate exclusively or largely or some oxygen at the positive electrode, with no or little or diluted chlorine produced.

### “Asymmetric Thermal Amplification”

Example embodiment electrodes and electrochemical cells have also allowed the development of a new approach to maximizing performance termed “Asymmetric Thermal Amplification”. This approach involves amplifying the overall performance of electrochemical cells by asymmetrically heating and/or cooling, both or either of, the positive electrode(s) and/or the negative electrode(s), in an electrochemical cell. In an example cell this can involve asymmetrically heating or cooling the positive electrode or the negative electrode. Asymmetric heating/cooling may be used where the performance of the negative electrode is optimum at one temperature whereas the performance of the positive electrode is optimum at a different temperature.

Asymmetric thermal amplification is based on the recognition that, in certain example embodiment electrochemical cells, it may be more energy and cost-effective, overall, to asymmetrically heat or cool the electrodes rather than the entire apparatus. Asymmetric thermal amplification may also increase performance in an electrochemical cell without the energy or economic cost normally required.

Accordingly, there is provided a method for amplifying the overall performance of an electrochemical cell, the method comprising the steps of: selectively heating and/or cooling positive and negative electrodes so as to maintain the positive electrode at a different temperature than the negative electrode;

In cells with more than one, or many positive electrodes and negative electrodes, thermal amplification may involve heating or cooling some or all of the positive electrodes, or heating or cooling some or all of the negative electrodes, or a combination of heating some or all of one type of electrode in a cell, either positive electrodes or negative electrodes, whilst simultaneously cooling some or all of the counterpart electrodes.

Asymmetric thermal amplification may be achieved by any and all types of cooling or heating, howsoever brought about.

While asymmetric thermal amplification may be employed in example embodiment cells with example embodiment electrodes, it is not limited to the use of such cells and such electrodes. Any electrodes and any electrochemical cells, without limitation, may be used to carry out thermal amplification.

### Example Applications

In example embodiments, gas diffusion electrodes and/or zero-gap cells of the types described herein may be used in electro-synthetic cells to facilitate electrochemical reactions, including but not limited to electrochemical reactions involving gas depolarisation of one or more electrodes, provide for and make practically viable a range of devices and applications. For example, they may more efficiently facilitate water electrolysis reactions than conventional electrolysers. In these and other respects they may be useful in the electrochemical manufacture of materials including but not limited to: (a) hydrogen peroxide, (b) fuels, chemicals or polymers from CO₂, (c) ozone, (d) chlorine, (e) caustic (with chlorine), (f) caustic (without chlorine), (g) potassium permanganate, (h) chlorate, (i) perchlorate, (j) fluorine, (k) bromine, (1) persulfate, (m) CO₂ from methane, and others. Alternatively, they can also be usefully employed in: (n) electrometallurgical applications, such as metal electrowinning, (o) pulp and paper industry applications, including but not limited to: (p) “black liquor” electrolysis, (q) “Tall Oil recovery” and (r) chloride removal electrolysis.

In other example embodiments, gas diffusion electrodes and/or zero-gap cells of the above type may be used in electro-energy cells, including but not limited to: (s) fuel cells and related devices, including but not limited to hydrogen-oxygen fuel cells, alkaline fuel cells, phosphoric acid fuel cells, methanol/ethanol fuel cells, and so forth, and (t) batteries, including but not limited to batteries with air electrodes and batteries where gas generation in form of bubbles is possible but unwanted, including but not limited to nickel metal hydride batteries, Ni—Cd batteries, lead acid batteries, and so forth.

The following further examples provide a more detailed discussion of particular embodiments. The further examples are intended to be merely illustrative and not limiting to the scope of the present invention.

### Using a Repulsive Capillary Action to Direct Gas Formation in an Electrode

The effect of relatively favouring or disfavouring gas/gas bubble formation in this manner at particular locations in an electrode may be expected to manifest itself in the quantity of gas generated at those locations. This may be evidenced by the size of the bubbles formed and the volume of the gas that they envelop, at the different locations within the electrode.

In electrochemistry, gas bubble formation involves the initial creation of nanobubbles with very high internal pressures. These then spontaneously expand into larger bubbles with lower internal pressures. The relative volumes of the gas bubbles formed at different locations, under conditions of constant internal pressure, may be used to illustrate how gas formation may be directed to different locations.

Table 1 illustratively depicts the impact of external capillary pressures on the progression of bubble expansion at the different locations in electrode 100 in FIG. 1. The bubble sizes have been calculated using equations (1) and (2). For the purposes of demonstration, we have considered the initial nanobubbles to have an internal ‘Laplace’ pressure of 60 bar.

The top line in Table 1 shows newly formed bubbles. The bubbles are calculated to have bubble radii of 0.02 μm at the interface with the non-conductive layer 104, 0.03 μm within the porous conductive layer 101, and 0.03 μm at the interface with the open solution 105.

The bubbles then expand with an accompanying decrease in their internal pressure, until that internal pressure approaches the ambient pressure of the liquid electrolyte, namely 1 bar. For the purposes of this example, we will consider the volume of gas produced at each location by comparing the volume of gas in bubbles whose internal pressure is 1% larger than the ambient pressure; that is, at 1.01 bar when the ambient pressure is 1 bar. We will then consider what happens when the bubble internal pressure approaches ambient (i.e. 1 bar).

As can be seen in Table 1, during this expansion process the bubble radii are strongly influenced by the capillary pressures to which they are subjected. Thus, at the interface with the non-conductive layer 104, where the capillary pressure is +15.6 bar, the bubble radius expands from 0.02 μm initially (at 60 bar internal pressure), to 0.10 μm finally (at 1.01 bar internal pressure). This is a 5-fold increase.

By contrast, a bubble within the body of the porous, conductive layer 101, where the capillary pressure is +1.6 bar, will grow from a radius of 0.03 μm initially (at 60 bar internal pressure) to 1.00 μm finally (at 1.01 bar internal pressure). This equates to a 33.3-fold increase in bubble radius.

Finally, a bubble at the interface with the open solution 105, which is effectively subjected to no capillary pressure, is calculated to grow from an initial radius of 0.03 μm (at 60 bar internal pressure) to 156.82 μm at 1.01 bar internal pressure. This is a 5,227-fold increase in radius.

The critical point is that, at an internal pressure of 1.01 bar, the volumes of gas enclosed by the bubbles at the different locations in electrode 100 are very different. They can be calculated as follows.

The volume of a spherical bubble is given by the equation:

V=(4/3)πR³ (3)

where R is the radius of the bubble (in units of: m).

Thus, at internal pressures of 1.01 bar at the interface 104 with the non-conductive layer 102 a bubble of 0.10 μm encloses 0.0004 μm³ of gas. At the same internal pressure of 1.01 bar within the body of the conductive layer 101, a bubble of 1.00 μm encloses 4.16 μm³ of gas. And at the same internal pressure of 1.01 bar at the interface 105 with the open solution 103, a bubble of 0.10 μm encloses 16.1 million μm³ of gas.

The practical effect of the different capillary pressures in electrode 100 is therefore that the gas formed at the interface 105 with the open solution 103 contains:

16.1*10⁶ /(0.0004+4.16+16.1*10⁶)×100=99.99997% of the gas produced by the electrode.

That is, the overwhelming majority of the gas produced by the electrode 100 is formed at the interface 105 with the open solution 103. In other words, gas formation is directed by the structure of electrode 100 to that location.

Of course, this is illustrative only because, in fact, as the internal pressure of the bubble at the interface 105 with the open solution 103 approaches ambient (1 bar), the bubble size approaches infinity. By contrast, bubbles at the interface 104 with the non-conductive layer 102 are only 0.10 μm and bubbles within the body of the conductive layer 101 are only 1.00 μm at ambient pressure. Thus, effectively, 100% of the gas generated by the electrode will be directed to and formed at the interface 105 with the open solution 103.

If we now make a similar comparison at the different locations in gas diffusion electrode 110 of FIG. 2(A), then surprising new trends become apparent.

Table 2 shows the impact of the capillary pressures on the progression of bubble expansion at the different locations in electrode 110. The bubble sizes in Table 2 have been calculated using equations (1) and (2).

As can be seen in the top line of Table 2, a newly-formed bubble having a high internal pressure (chosen as 60 bar in this example) will have a calculated bubble radius of 0.03 μm at interface 115 with the gas side layer 112. A bubble with the same internal pressure located within the conductive liquid-side layer 111 will have a calculated radius of 0.02 μm, and a bubble with the same internal pressure located at the interface 116 with the liquid solution 113 will have a calculated radius of 0.03 μm.

The bubbles then expand spontaneously. At an internal pressure of less than 7.67 bar, the radius of the bubble located at interface 115 with the gas side layer 112 will be infinite in size. At the same internal pressure of less than 7.67 bar, bubbles located within the conductive liquid-side layer 111 and at the interface 116 with the liquid solution 113 will have finite but trivial sizes.

Thus, all of the gas produced by the electrode 110 is formed at the interface 115 with the gas side layer 112.

Moreover, the volume of gas directed to that location drastically exceeds the volume of gas directed to interface 105 in electrode 100 of FIG. 1. This is because the repulsive capillary action at interface 115 in FIG. 2(A) facilitated and accelerated the rate of gas production, whereas the attractive capillary actions employed in FIG. 1, did not.

It is also to be understood that gas bubbles formed at the interface 115 with the gas side layer 112 are subject at all times to being drawn into and taken up by the gas side layer 112. That is, if the bubbles touch the gas side layer 112, they will be drawn into it and taken up by it. This will inevitably occur as the bubble grows extremely large.

### Tailoring a Repulsive Capillary Action or a Gradient of Attractive-to-Repulsive Capillary Actions in an Electrode

Referring to FIG. 2, we now examine how capillary action within an electrode may be adjusted in order to maximally favour and direct gas formation in an electrode. In this respect, we consider the situation where the conductive liquid side layer 111, and the non-conductive gas side layer 112 each have smaller pores than in the last example. Smaller pores generally create higher capillary pressures.

For example, consider the situation where the conductive, liquid side layer 111 has an average pore radius of 0.025 μm (average pore diameter=0.05 μm). If the contact angle of the electrolyte with the porous, permeable electrode is unchanged at 5°, then the capillary pressure, P_{c}, can be calculated using equation (1) to be +6,248,850 N/m², which equates to +62.5 bar. The positive sign indicates that the KOH liquid solution 113 is attracted to and drawn into the conductive, porous, hydrophilic, gas-permeable and liquid-permeable layer 111.

Consider further the case where the pores of the non-conductive, porous, hydrophobic, gas-permeable and liquid-impermeable layer 112 have an average radius of 0.025 μm (average diameter 0.05 μm), which is substantially smaller than in the previous example. If the contact angle between the aqueous 6 M KOH solution (0.078409 N/m surface tension) and the hydrophobic material is unchanged at 115°, the capillary pressure, P_{c}, will be −2,650,966 N/m², which equates to −26.5 bar. Note that P_{c} is a negative number, meaning that the KOH solution is repelled by (and gas/gas bubbles attracted to) the pores of the hydrophobic material.

Table 3 shows the impact of these capillary pressures on the progression of bubble expansion at the different locations in electrode 110. The bubble sizes in Table 3 have been calculated using equations (1) and (2).

As can be seen in the top line of Table 2, newly-formed bubbles having high internal pressures (chosen as 60 bar) have calculated bubble radii of: 0.05 μm at interface 115 with the gas side layer 112 0.01 μm within the conductive liquid-side layer 111, and 0.03 μm at the interface 116 with the liquid solution 113.

The bubbles then expand spontaneously. At an internal pressure of less than 27.6 bar, the bubble radii are: Infinite in size at interface 115 with the gas side layer 112 Finite and trivial in size within the conductive liquid-side layer 111, and Finite and trivial in size at the interface 116 with the liquid solution 113.

Thus, all of the gas produced by the electrode 110 is formed at the interface 115 with the gas side layer 112.

Moreover, the volume of gas directed to that location drastically exceeds the volume of gas directed to interface 115 with the gas side layer 112 in the previous example. This was because, bubbles at that location become infinitely large at a much earlier stage in the process of bubble formation (namely, at an internal pressure of <27.6 bar vs an internal pressure of <7.67 bar). This occurs because the repulsive capillary action at interface 115 was much larger than in the previous example, so that it better facilitated and accelerated the rate of gas production.

It is also to be understood that gas bubbles formed at the interface 115 with the gas side layer 112 are subject at all times to being drawn into and taken up by the gas side layer 112. That is, if the bubbles touch the gas side layer 112, they will be drawn into it and taken up by it. This will inevitably occur as the bubble grows extremely large.

Similar effects can be obtained by increasing the hydrophobicity of the pores in the gas side layer 112 and/or increasing the hydrophilicity of the pores in the liquid side layer. That is, using equation (1) and (2) it can also be shown that similar effects to the above can be achieved by increasing the contact angle of the gas side layer 112 and/or decreasing the contact angle of the liquid side layer 111, whilst keeping the average pore size of those layers unchanged.

It can therefore be concluded that to increasingly favour and direct bubble formation one should combine: a liquid side layer 111 of a smaller pore size and/or smaller contact angle with the liquid electrolyte (where the liquid side layer 111 may comprise a conductive, porous, hydrophilic, gas-permeable and liquid-permeable layer), with a gas side layer 112 of a smaller pore size and/or larger contact angle with the liquid electrolyte (where the gas side layer may comprise a non-conductive, porous, hydrophobic, gas-permeable and liquid-impermeable layer), where the distance between interface 116 and interface 115 is small.

The above combination amplifies the gradient of capillary actions within a porous electrode 110, from highly attractive in the liquid side layer 111, to highly repulsive in the gas side layer 112. The steepness of this gradient controls the proportion and the volume of gas directed to the interface 115 with the gas side layer 112.

It is also possible to employ multiple liquid side layers 111, each with their own attractive capillary pressure, to better tailor a gradient of capillary pressures across the electrode. The cross-sectional gradient of capillary actions may thereby also be made to be stepped, linear, curved, asymmetric, asymptotic, or conform to some other linear or non-linear profile.

Other methods of tailoring or varying the intensity of a repulsive capillary action and/or the steepness of the cross-sectional gradient of capillary actions from attractive to repulsive, involve adjusting: the overall porosity of the liquid-side layers (that is, the volume fraction of the layer material within the liquid-side layer(s)), and/or incorporating hydrophobic strands, fibres or particulates, that may be solid state materials or porous, gas-permeable and liquid-impermeable materials, within the liquid-side layer(s). The hydrophobic fibres, strands or particulates may form nucleation points for assisted gas bubble formation and/or pathways for assisted transmission of gas/gas bubbles toward the zone of most negative capillary pressure within the electrode. Alternatively, or additionally, the hydrophobic fibres, strands or particulates may help tailor the gradient of attractive to repulsive capillary actions (positive to negative capillary pressures) within the electrode, and/or incorporating hydrophobic micro- or nanoscopic hierarchical structure at particular locations within the electrode, for instance within the structure of the liquid side layer or particles present in the liquid side layer. Hierarchical structure refers to the phenomenon where a structure may contain millimetre-sized structural elements that, in turn, contain distinct micron-sized structural elements that, in turn, contain within them distinct nano-sized structural elements, so that a hierarchy of structural elements, each of different gross physical dimension, is present. Some of those structural elements may then be hydrophobic or even superhydrophobic, with the surrounding regions being hydrophilic. Within an embodiment electrode, the hydrophobic or superhydrophobic locations may form nucleation points for assisted gas/gas bubble formation and/or pathways for assisted transmission of gas/gas bubbles toward the zone of most negative capillary pressure within the electrode. Alternatively, or additionally, the hydrophobic or superhydrophobic locations may help tailor the gradient of attractive to repulsive capillary actions (positive to negative capillary pressures) within the electrode. In example embodiments, the more hydrophobic the porous electrode (due to the complexity and tortuosity of the hierarchical structure) at a particular location, the more repulsive the capillary action toward the liquid/gel electrolyte, and therefore the greater the extent to which gas formation will be favoured and/or directed to that location. The gas formation location may then form nucleation points for assisted gas/gas bubble formation and/or pathways for assisted transmission of gas/gas bubbles toward the zone of most negative capillary pressure within the electrode. This is, counter-intuitively, the case even for extremely complex and tortuous hierarchical structures that would normally be expected to impede and hinder gas transit, relative to smoother surfaced analogues. For example, such hydrophobic or superhydrophobic regions may be present on the surface of the catalyst in the electrode.

### Establishing a Repulsive Capillary Action or a Gradient of Attractive-to-Repulsive Capillary Actions in an Electrode

What, then, are suitable capillary pressures or gradients of capillary pressures to use in an electrode? That will depend very much on the particular system involved.

For example, recent work by Henry S. White of Utah University (J. Phys. Chem. Lett., 2017, 8 (11), pp 2450-2454) showed that the concentration of dissolved oxygen in an aqueous electrolyte must rise to around 0.17 M before an oxygen nanobubble will form. This is 130-times more than the equilibrium saturation concentration of dissolved oxygen at atmospheric pressure, which is 0.00133 M. The partial pressure of dissolved oxygen, under equilibrium saturation conditions, in aqueous solution at 20° C. is around 0.032 bar. In order to form an oxygen bubble, the water must therefore become supersaturated, with the partial pressure of dissolved oxygen rising to 4.16 bar before a nanobubble will form.

Thus, if the wetted, conducting, liquid-side layer 111 of an electrode 110 starts generating oxygen at a constant and high rate, then the partial pressure of dissolved oxygen in the water within the liquid-side layer 111 and at interface 116 will, initially, rise from 0 bar up to 4.16 bar without oxygen bubbles forming. Thereafter, oxygen bubbles will form continuously with the partial pressure of dissolved oxygen remaining at 4.16 bar.

Later work by the same author in a paper entitled “Critical Nuclei Size, Rate, and Activation Energy of H₂ Gas Nucleation” (unpublished at the time of preparing this specification) indicated that the concentration of dissolved hydrogen in an aqueous electrolyte must rise to around 0.21 M before a hydrogen nanobubble forms. This is around 260-times more than the equilibrium saturation concentration of dissolved hydrogen at atmospheric pressure. The partial pressure of dissolved hydrogen, under equilibrium saturation conditions, in aqueous solution at 20° C. is around 0.0185 bar. In order to form a hydrogen bubble, the water must therefore become supersaturated, with the partial pressure of dissolved hydrogen rising to 4.80 bar before a nanobubble will form.

Thus, if the wetted, conducting, liquid-side layer 111 of an electrode 110 starts generating hydrogen gas at a constant and high rate, then the partial pressure of dissolved hydrogen in the water within the liquid-side layer 111 and at interface 116 will, initially, rise from 0 bar up to 4.80 bar without hydrogen bubbles forming. Thereafter, hydrogen bubbles will form continuously with the partial pressure of dissolved oxygen remaining at 4.80 bar.

Accordingly, if one wished to design an example embodiment electrode with a liquid-side layer 111 that generated hydrogen or oxygen gas and with a gas side layer 112 that efficiently extracted and removed that hydrogen and/or oxygen gas in a ‘bubble-free’ manner as it was being formed, then: it would be necessary to ensure that the repulsive capillary pressure at interface 115 and the gradient of capillary pressures between interface 116 and interface 115 was such that all of the gas being continuously formed could migrate to interface 115 without forming a gas bubble. That is, the level of supersaturation of oxygen or hydrogen at interface 116 and at every location within the liquid side layer 111 would have to be maintained such that their partial pressures never reached 4.16 bar and 4.80 bar respectively (and therefore gas bubbles were never formed).

The level of supersaturation would, of course, depend on the rate at which the gas was being generated (i.e. on the current being passed through the electrode). One may use the model of Ficks law of diffusion to calculate the distance that 100% of newly-formed, dissolved hydrogen and oxygen gas will migrate in pure water from a location whose partial pressure of hydrogen or oxygen was maintained just below 4.80 bar or 4.16 bar, respectively. That is, one may calculate the distance that dissolved hydrogen or oxygen can migrate without forming a bubble at different rates of gas generation (i.e. different electrode currents).

The diffusion coefficient of oxygen in pure water at 25° C. is 2×10⁻⁵ cm² sec⁻¹ and that of hydrogen is 3.61×10⁻⁵ cm² sec⁻¹ (J Phys Chem 1970, 74, 1747). The values at 20° C. can be imputed to be 1.78×10⁻⁵ sec⁻¹ and 3.17×10⁻⁵ sec⁻¹ respectively. (The equilibrium saturation solubility of oxygen in pure water at 21° C. is 0.00135 mol/L and of hydrogen in pure water is 0.000808 mol/L (Russ. J. Phys Chem 1964, 44, 1146). The equilibrium saturation concentrations of oxygen and hydrogen in pure water at 20° C. can be imputed to be 0.00133 mol/L and 0.000816 mol/L respectively).

For a differential pressure of 1 bar, using pure water as the electrolyte at 20° C., the results in Table 4 are obtained.

TABLE 4
Calculated distance according to Ficks Law of diffusion, that 100%
of newly formed gas will be able to migrate without bubble formation
in pure water at 20° C. and atmospheric pressure (i.e. from
a location whose partial pressure of hydrogen or oxygen was maintained
just below 4.80 bar or 4.16 bar, respectively).

| | Distance that dissolved | | Distance that dissolved | |
|---|---|---|---|---|
| | hydrogen can migrate | | oxygen can migrate | |
| Current Density | without forming a bubble | | without forming a bubble | |
| (mA/cm²) | Pure water, 20° C. | | Pure water, 20° C. | |
| 1000 | 13 | μm | 12 | μm |
| 750 | 17 | μm | 16 | μm |
| 500 | 26 | μm | 23 | μm |
| 200 | 64 | μm | 58 | μm |
| 100 | 129 | μm | 116 | μm |
| 50 | 255 | μm | 231 | μm |

Table 4 indicates that if the gradient of capillary pressures between interface 116 and interface 115 is 1 bar and the electrolyte is pure water at 20° C., then the distance between interface 116 and interface 115 should be no more than: 13 μm for a hydrogen generating electrode 110 operating at 1000 mA/cm²; 12 μm for an oxygen generating electrode 110 operating at 1000 mA/cm²; and 255 μm for a hydrogen generating electrode 110 operating at 50 mA/cm²; 231 μm for an oxygen generating electrode 110 operating at 50 mA/cm².

An electrode operating under these conditions would then further need a differential capillary pressure of 1 bar between interfaces 115 and 116. This can only be achieved by having a repulsive capillary pressure of −1 bar at interface 115 (since interface 116 necessarily has no capillary pressure).

This example serves to illustrate how one may determine the minimum suitable: repulsive capillary pressure at interface 115, capillary pressure gradient between interfaces 116 and 115, and thickness of liquid side layer 111, for an electrode 110 operating to generate hydrogen gas or/oxygen gas at 20° C. in pure water.

It is to be understood that: (i) the minimum suitable parameters may need to be exceeded for reliable operation, and (ii) the above parameters are theoretical only and may need to be tested empirically.

In practice, pure water is almost never used as an electrolyte in electrochemical cells. Water electrolyzers (that generate hydrogen at one electrode and oxygen at the other electrode) more commonly use electrolytes like aqueous 6 M KOH. Table 5 provides illustrative data for a 6 M KOH electrolyte at 70° C. This data is based on an assumption that the same multipliers apply for gas bubble generation in 6 M KOH at 70° C. as pure water at 20° C. That is, the data in Table 5 assumes that oxygen nanobubbles first form at 130-times the equilibrium saturation concentration of dissolved oxygen in 6 M KOH at 70° C., while hydrogen nanobubbles first form at 260-times the equilibrium saturation concentration of dissolved hydrogen oxygen in 6 M KOH at 70° C. Since, in 6 M KOH at 70° C. and atmospheric pressure, the equilibrium saturation partial pressure of oxygen is only 0.00327 bar and of hydrogen is only 0.00274 bar, microbubble formation is assumed to commence at a supersaturation partial pressures of 0.425 bar of oxygen and 0.712 bar of hydrogen.

TABLE 5
Calculated distance according to Ficks Law of diffusion, that
100% of newly formed gas will be able to migrate without bubble
formation in 6M KOH at 70° C. and atmospheric pressure (i.e.
from a location whose partial pressure of hydrogen or oxygen
was maintained just below 0.712 bar or 0.425 bar, respectively).

| | | | Distance that dissolved | |
|---|---|---|---|---|
| | Distance that dissolved | | oxygen can migrate | |
| | hydrogen can migrate | | without forming a | |
| Current Density | without forming a bubble | | bubble 6M KOH, | |
| (mA/cm²) | 6M KOH, 70° C. | | 70° C. | |
| 1000 | 1.8 | μm | 1 | μm |
| 750 | 2.4 | μm | 1 | μm |
| 500 | 3.6 | μm | 2 | μm |
| 200 | 9 | μm | 5 | μm |
| 100 | 18 | μm | 9 | μm |
| 50 | 36 | μm | 19 | μm |

As can be seen in Table 5, if the gradient of capillary pressures between interface 116 and interface 115 is 1 bar and the electrolyte is 6 M KOH at 70° C., then the distance between interface 116 and interface 115 should not be more than: 1.8 μm for a hydrogen generating electrode 110 operating at 1000 mA/cm²; 1 μm for an oxygen generating electrode 110 operating at 1000 mA/cm²; and 36 μm for a hydrogen generating electrode 110 operating at 50 mA/cm²; 19 μm for an oxygen generating electrode 110 operating at 50 mA/cm².

An electrode operating under these conditions would also need a differential capillary pressure of 1 bar between interfaces 115 and 116, which can only be achieved by having a repulsive capillary pressure of −1 bar at interface 115 (since interface 116 necessarily has no capillary pressure).

TABLE 6
Calculated distance according to Ficks Law of diffusion,
that 100% of newly formed hydrogen will be able to
migrate without bubble formation in 6M KOH at 70°
C. at different liquid (electrolyte) pressures.

| | Distance that dissolved hydrogen can | | | | | | | | | |
|---|---|---|---|---|---|---|---|---|---|---|
| | migrate without forming a bubble | | | | | | | | | |
| | (in 6M KOH, 70° C.) at a liquid | | | | | | | | | |
| | pressure of: (also: maximum thickness | | | | | | | | | |
| Current | of liquid side layer for hydrogen | | | | | | | | | |
| Density | generation in 6M KOH at 70° C.) | | | | | | | | | |
| (mA/cm²) | 1 bar | | 3 bar | | 10 bar | | 30 bar | | 100 bar | |
| 1000 | 1.8 | μm | 5.4 | μm | 18 | μm | 54 | μm | 180 | μm |
| 750 | 2.4 | μm | 7.2 | μm | 24 | μm | 72 | μm | 240 | μm |
| 500 | 3.6 | μm | 10.8 | μm | 36 | μm | 108 | μm | 360 | μm |
| 200 | 9 | μm | 27 | μm | 90 | μm | 270 | μm | 900 | μm |
| 100 | 18 | μm | 54 | μm | 180 | μm | 540 | μm | 1800 | μm |
| 50 | 36 | μm | 108 | μm | 360 | μm | 1080 | μm | 3600 | μm |

TABLE 7
Calculated distance according to Ficks Law of diffusion,
that 100% of newly formed oxygen will be able to
migrate without bubble formation in 6M KOH at 70°
C. at different liquid (electrolyte) pressures.

| | Distance that dissolved oxygen can | | | | | | | | | |
|---|---|---|---|---|---|---|---|---|---|---|
| | migrate without forming a bubble | | | | | | | | | |
| | (in 6M KOH at 70° C.) at a liquid | | | | | | | | | |
| | pressure of: (also: maximum thickness | | | | | | | | | |
| Current | of liquid side layer for oxygen | | | | | | | | | |
| Density | generation in 6M KOH at 70° C.) | | | | | | | | | |
| (mA/cm²) | 1 bar | | 3 bar | | 10 bar | | 30 bar | | 100 bar | |
| 1000 | 1.0 | μm | 3 | μm | 10 | μm | 30 | μm | 100 | μm |
| 750 | 1.3 | μm | 3.9 | μm | 13 | μm | 39 | μm | 130 | μm |
| 500 | 1.9 | μm | 5.7 | μm | 19 | μm | 57 | μm | 190 | μm |
| 200 | 5 | μm | 15 | μm | 50 | μm | 150 | μm | 500 | μm |
| 100 | 9 | μm | 27 | μm | 90 | μm | 270 | μm | 900 | μm |
| 50 | 19 | μm | 57 | μm | 190 | μm | 570 | μm | 1900 | μm |

It is to be understood that other conditions may change the parameters for electrode design. For example, the pressure of the liquid electrolyte (which is distinct and different to the capillary pressure) may be changed.

Table 6 and Table 7 indicate the distance that dissolved hydrogen or oxygen is calculated to be able to migrate in 6 M KOH at 70° C. without forming a bubble at different rates of gas generation (i.e. different electrode currents), for various liquid pressures.

As can be seen in Table 6 and Table 7, if the gradient of capillary pressures between interface 116 and interface 115 is 1 bar and the electrolyte is 6 M KOH at 70° C. pressurised to a liquid pressure of 30 bar, then the distance between interface 116 and interface 115 should not be more than: 54 μm for a hydrogen generating electrode 110 operating at 1000 mA/cm²; 30 μm for an oxygen generating electrode 110 operating at 1000 mA/cm²; and 1080 μm for a hydrogen generating electrode 110 operating at 50 mA/cm²; 570 μm for an oxygen generating electrode 110 operating at 50 mA/cm².

An electrode operating under these conditions would also need a differential capillary pressure of 1 bar between interfaces 115 and 116, which can only be achieved by having a repulsive capillary pressure of −1 bar at interface 115 (since interface 116 necessarily has no capillary pressure).

It is to be understood that the capillary pressure differential may be increased to, for example, 2 bar, 4 bar, 8 bar, 16 bar, 32 bar, or so forth. In that case, the maximum distance between interface 116 and interface 115 may be adjusted in correspondingly suitable proportions.

It is also to be understood that the rate of diffusion of dissolved gases like hydrogen or oxygen may be influenced by the overall porosity of the liquid-side layers 111 (that is, the volume fraction of the layer material within the liquid-side layer(s)). As such, the diffusion rates would have to first be measured in the liquid side layer in order to make reliable calculations.

It is further to be understood that, in order to generate the required volumes of gas, it may be necessary to design electrode 110 to have liquid side layers 111 that are thicker than the maximum recommended. In such a case, it may be necessary to assist gas formation and transport within the liquid side layer. As noted in the previous example, the inventors have discovered that this may be achieved by incorporating hydrophobic strands, fibres or particulates, that may be solid state materials or porous, gas-permeable and liquid-impermeable materials, within the liquid-side layer(s). The hydrophobic fibres, strands or particulates may form nucleation points for assisted gas bubble formation and/or pathways for assisted transmission of gas/gas bubbles toward the zone of most negative capillary pressure within the electrode. Ideally, the hydrophobic fibres, strands or particulates form part of a continuous pathway or network that connects to the zone of most negative capillary pressure within the electrode; and/or incorporating hydrophobic micro- or nanoscopic hierarchical structure at particular locations within the electrode, for instance within the structure of the liquid side layer or within particles present in the liquid side layer. Within an embodiment electrode, the hydrophobic or superhydrophobic locations may form nucleation points for assisted gas/gas bubble formation and/or pathways for assisted transmission of gas/gas bubbles toward the zone of most negative capillary pressure within the electrode. Ideally, the hydrophobic hierarchical structure form part of a continuous pathway or network that connects to the zone of most negative capillary pressure within the electrode.

Very much higher current densities may be used if higher weight percentages of PTFE are included in the liquid side layer 111 and if more consistent PTFE networks are created in the electrode. For example, at current densities of 200 mA/cm² at 70° C., our studies showed an absence of observable bubbles on or about the liquid side layer 111 (100 μm thick; 50 wt % PTFE) during operation, with all hydrogen gas generated passing through the interface 115 into the gas side layer 112.

Table 6 shows, however, that the maximum thickness of a liquid side layer operating at 200 mA/cm² was 9 μm, so that this electrode should have generated bubbles and not been bubble-free.

The situation was explained by the fact that the PTFE particulates in the liquid side layer 111 fibrillated during manufacture of the layer and thereby provided a continuous hydrophobic 3D network that assisted transmission of gas/gas bubbles to the ePTFE, which was the zone of most negative capillary pressure within the electrode. PTFE repels water, meaning that a nanoscopic spaces is created between the PTFE surface and the water. It appears that gases may nucleate within that space and be transported along that space if a suitable pressure gradient is present.

On this basis, it can be surmised that high proportions of fibrillated PTFE can increase the maximum layer thickness by at least, but possibly substantially more thanll-fold.

### EXAMPLE 8

### Assisting the Operation of Non-Optimum Example Embodiment Electrodes by Applying an Overpressure to the Liquid Electrolyte. Repairing Non-Optimum Regions on Example Embodiment Electrodes

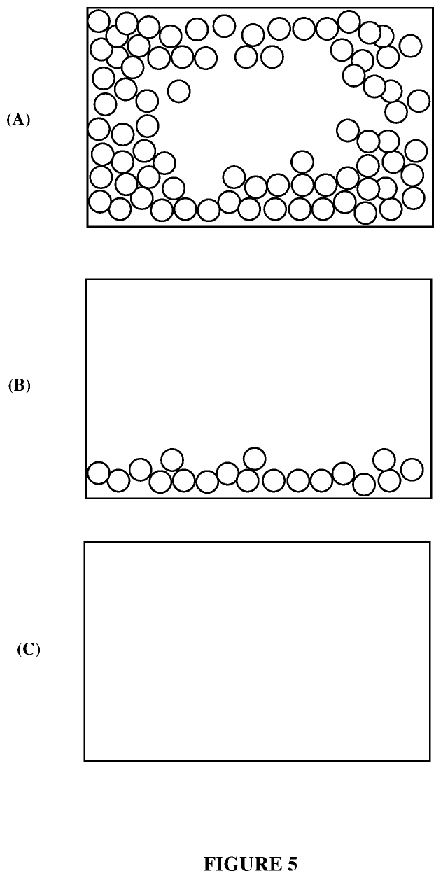

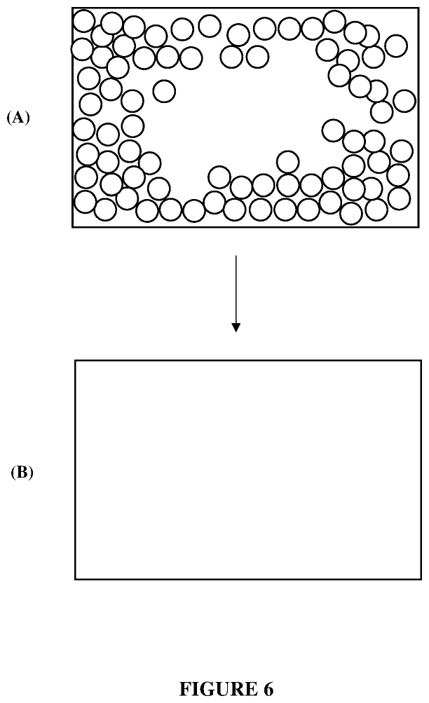

FIG. 5 provides photographs showing the surface 116 of an excessively thick (500 μm) liquid side layer 111 of an example embodiment gas diffusion electrode 110 fabricated according to the previous example, during operation as a hydrogen-generating negative electrode in an alkaline water electrolyzer using 6 M KOH electrolyte.

FIG. 5(A) is a photograph of the example embodiment electrode 110 while operating at 300 mA/cm² with the liquid electrolyte at atmospheric pressure. As can be seen, the electrode surface 116 has a small number of stray bubbles attached to it. This is to be expected given that the liquid side layer 111 was too thick.

FIG. 5(B) shows the same electrode under the same operating conditions, but with a small overpressure of 0.4 bar applied to the liquid electrolyte. That is, the liquid electrolyte was pressurized to 0.4 bar above atmospheric pressure, while the hydrogen gas in the gas side layer 112 was only at atmospheric pressure. As can be seen, no bubbles are present on the surface of the electrode, except at its lower edge (along the bottom of the photograph in FIG. 5(B)). The bubbles at this edge arise because of the presence of a ridge created by a polymer (polypropylene) frame that held the electrode in place during the testing. At the polymer frame ridge, melted polypropylene had penetrated the porous structure of the ePTFE membrane so that the negative capillary pressure of the underlying porous, hydrophobic substrate was not present, or, conversely, the ePTFE membrane was no longer porous. Gas formation at this location was therefore not bubble-free, being equivalent to the situation in an open liquid solution.

To overcome the effect of the loss of the ePTFE porosity and negative capillary pressure at the edge of the electrode, the other three edges shown at the top, left and right of

FIG. 5(B) had an uncoated ePTFE membrane (product code QL217, having average pore radius 0.05 μm, provided by GE Energy) welded on top of them. As can be seen at the top, left and right edges of FIG. 5(B), the effect of overwelding the ePTFE membrane was to entirely eliminate the presence of bubbles at these edges. In effect, the ePTFE layer provided the requisite porosity and repulsive capillary pressure, thereby avoiding bubble formation.

FIG. 5(C) shows a photograph of the same electrode, operating under the same conditions as in FIG. 5(B), but with the bottom edge also over-welded with an ePTFE membrane. As can be seen in FIG. 5(C), no bubbles whatsoever are present on the electrode during operation, even at the applied current of 300 mA/cm².

This example serves to illustrate that an example embodiment electrode that operates non-optimally may be induced to operate optimally by applying an overpressure to the liquid electrolyte. Non-optimum regions of example embodiment electrodes may also be “repaired” using techniques such as those described above.

### EXAMPLE 9

### Applying a “Bubble-Suppression” Layer

Similar effects may be achieved using other approaches. Another approach involves creating a capillary action that disfavors bubble formation at the interface 116. That is, rather than having an electrode surface (i.e. interface 116) at which capillary actions do not formally influence bubble formation, the surface 116 may be modified to create capillary actions that disfavour bubble formation.

In one example, this may be achieved by overlaying the surface 116 of the electrode 110 with a “bubble-suppression” layer, which may be a non-conducting, porous, hydrophilic layer. The electrode surface 116 of the example embodiment electrode depicted in FIG. 5(A) was covered or overlaid with a non-conducting, porous, hydrophilic, polyethersulfone layer or membrane having an average pore radius of 0.1 μm (0.2 μm average pore diameter) (Tradename: SUPOR200, supplied by Pall Corporation). The membrane was either hot-laminated or wet-laminated to the surface of the electrode, or held tight against the electrode surface by edge-welding.

The effect was to thereby create a strong, attractive capillary action at the surface 116 of the electrode 110. The pores of the polyethersulfone membrane, being small and strongly hydrophilic, draw water into them by a capillary action. The resulting capillary pressure had then to be overcome in order for bubbles to form at the electrode surface 116. If the contact angle of the electrolyte with the polyethersulfone membrane was 5°, then, the additional capillary pressure that would have had to be overcome during bubble formation would have been +1,562,213 N/m², which equates to +15.6 bar.

FIG. 6 depicts the surface of the resulting example embodiment electrode (overlaid with the above polyether sulfone filter membrane “bubble-suppression” layer) during hydrogen generation at 300 mA/cm² without any overpressure applied. FIG. 6(A) schematically depicts the electrode surface before affixing a bubble-suppression layer, and FIG. 6(B) schematically depicts the electrode surface after affixing the bubble-suppression layer. As can be seen, the surface is completely bubble-free.

Such “bubble-suppression” layers may also be used to construct cells employing example embodiment electrodes.

Bubble-suppression layers of this type may be attached to, fused to, bound to, or co-located tight against liquid side layers 111 by various means. For example, they may be laminated to the liquid side layer 111 while it is still wet. This may cause some of the fibrillating liquid side layer 111 to penetrate into and interlock with the porous structure of the bubble-suppression layer, producing a mechanical bond between them. In alternative techniques, the bubble-suppression layer may be held tight against the liquid side layer 111 by compression, or it may be welded around the edges of the liquid side layer 111 to the electrode to thereby maintain them in close contact. Various other attachment means known to the art may be used.

### Example Water Electrolyzers

Example embodiments may act as water electrolysers, that split water into hydrogen (H₂) at one electrode and oxygen (O₂) at the other electrode according to the reaction:

2 H₂O+electricity+heat O₂ (g)+2 H₂(g) E°_{cell}−1.23 V (vs SHE)

The Applicant has prepared example embodiment gas diffusion electrodes comprising ePTFE membrane substrates as gas side layers overcoated with liquid side layers incorporating a range of well-known water-splitting catalysts, utilizing poly(tetrafluoroethylene) (PTFE) as a binder and a fine Ni mesh as a current carrier. Combinations were studied of these as positive electrodes and negative electrodes in a two-electrode, benchtop water electrolysis cell. While twelve different catalysts were studied in all. Notable results involving only two of those catalysts here; namely, Raney Ni and cubical NiCo₂O₄ spinel. The work also describes an equivalent high-performing fuel cell, fabricated in the same desktop cell, and employing 20% Pd—Pt/CB as positive electrode and negative electrode catalyst.

Polypropylene-backed Preveil™ expanded PTFE (ePTFE) (‘Gortex’) membranes, produced by General Electric Energy were used in all experiments. These membranes were resistant to flooding to overpressures of >4 bar.

The cell held the liquid side layers of two incorporated electrodes in a facing disposition, 1-10 mm apart. The central cavity of the cell, between the electrodes, was filled with aqueous 6 M KOH electrolyte. Because the Gortex membranes (an expanded polytetrafluoroethylene (ePTFE) membrane) that formed the walls of the central cavity do not allow water to pass, the central cavity was liquid-fast. Behind each electrode in the cell was a sealed gas chamber, into which hydrogen (at the negative electrode) or oxygen (at the positive electrode) passed, through the ePTFE membrane electrode. The overwhelming majority of the gas produced by the ePTFE membrane electrodes was found to pass through the ePTFE membrane into the gas chamber behind them. For this reason, no inter-electrode diaphragm or ionomer was required in the cell. Stray gas bubbles that formed within the liquid electrolyte, at either of the electrodes, rose and exited the cell through the liquid headspace, which was filled with nitrogen at the start of each experiment.

To maintain a constant temperature, the entire cell was submersed in a stirred, temperature-controlled, water bath containing de-ionized water. The water-bath was wrapped with thermal insulation during the experiments. A heater-controller maintained the water bath at the set temperature. The sealed nature of the cell ensured that its gaseous and liquid contents did not contact or mix with the surrounding water.

Chronoamperometry of ePTFE Membrane-Based Electrolyzers

Electrochemical testing was then carried out on different combinations of catalyst+PTFE+Ni-mesh/ePTFE membrane electrodes in the above cell. To eliminate artefacts arising from transiently high or low activities (which is common in, particularly, Pt catalysts) and any possible sacrificial reactions, the catalytic electrodes were initially poised at a constant 10 mA/cm² for >1 h at 80° C. and their performance monitored.

The most active combination of electrodes using this approach involved a negative electrode containing a liquid side layer comprising a mixture of Raney Ni (388 g/m²), carbon black (CB) (5 g/m²) and PTFE (400 g/m²) with a Ni mesh current collector, deposited on a gas side layer comprising an ePTFE membrane (‘Raney Ni+CB+PTFE+Ni-mesh/ePTFE membrane’). When combined with a positive electrode, containing a liquid side layer containing cubical NiCo₂O₄ spinel (262 g/m²) and PTFE (240 g/m²) with a Ni mesh current collector, deposited on a gas side layer comprising an ePTFE membrane (‘NiCo₂O₄+PTFE+Ni-mesh/ePTFE membrane’), the resulting electrolyser required only 1.23-1.27 V to generate 10 mA/cm² over 1 h at 80±5° C. in 6 M KOH.

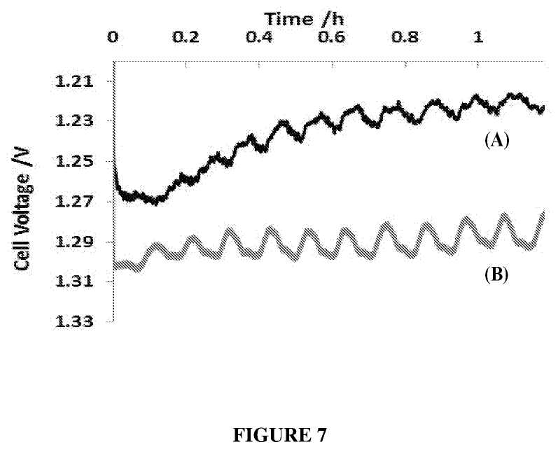

FIG. 7(A) depicts a typical chronoamperogram. As can be seen, the electrolyser initially required a cell voltage of 1.27 V to maintain the 10 mA/cm² current, however over 1 h, its cell voltage declined steadily to eventually stabilize at around 1.23 V.

The periodic voltage fluctuations that can be seen in FIG. 7(A) derived from notable temperature swings of about ±5° C. that occurred in the water bath as the heater-controller turned on and off during operation. The heater-controller struggled to maintain a fixed 80° C. temperature in the face of what was clearly a strong cooling effect created by the cell, which was operating at a potential far below the thermoneutral voltage. As predicted by theory, the cell was strongly endothermic.

In these experiments, carbon black was not included in the liquid side layer of the positive electrode due to the risk of carbon corrosion in the strongly oxidising environment that exists at the positive electrode. When incorporated in the liquid side layer of the negative electrode of alkaline water electrolysers, which has a strongly reducing environment, carbon black is not usually subject to corrosion. However, to confirm that the observed current did not include a component arising from carbon corrosion at the negative electrode, a control experiment was conducted under identical conditions, using negative electrodes in which the Raney Ni catalyst was replaced with non-catalytic carbon black. Reasonable voltages could not be obtained in these experiments.

To further confirm that the current was due to water electrolysis, the gases generated by each of the negative electrode and the positive electrode in the cell after 1 h of operation, were collected in upturned measuring cylinders filled with water, within a second water bath. At 10 mA/cm², a water electrolysis cell should produce 3.04 mL of H₂ (negative electrode) and 1.52 mL of O₂ (positive electrode) over 40 min. Where necessary, gas was also collected from the headspace of the cell. In an experiment at 10 mA/cm², the volume of gas collected from the negative electrode was 98.5% of the volume of hydrogen expected. The gas was also confirmed to be hydrogen (at the negative electrode) using gas chromatographic analysis. The gas produced at the positive electrode was also confirmed to be oxygen using gas chromatographic analysis.

Temperature-Dependent Current-Voltage Polarization Plots of ePTFE Membrane-Based Electrolyzers

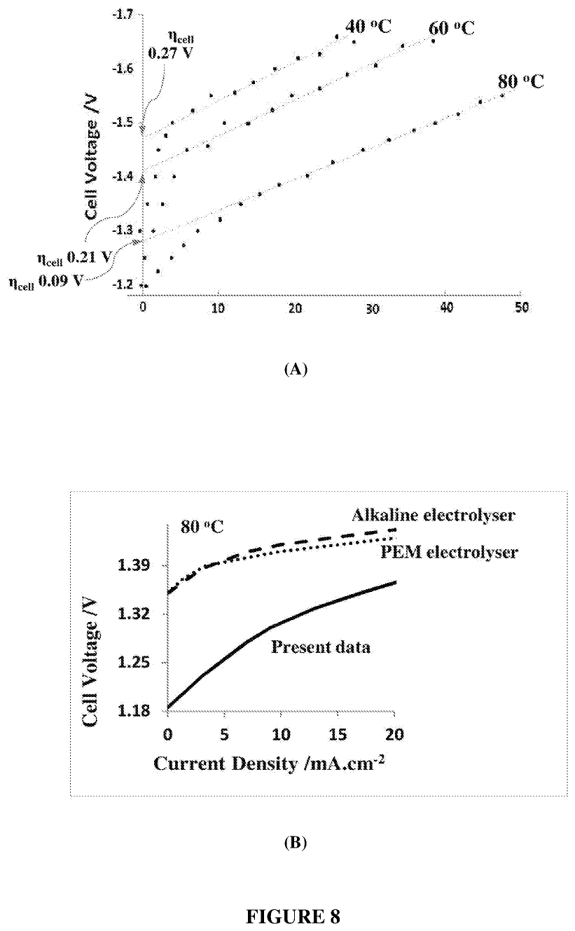

Polarisation curves were measured for the above electrolyser at different temperatures. FIG. 8(A) depicts the curves obtained for the Raney Ni+CB+PTFE+Ni-mesh/ePTFE membrane (negative electrode) and NiCo₂O₄+PTFE+Ni-mesh/ePTFE membrane (positive electrode) electrolyser at 45° C., 60° C., and 80° C.

As can be seen in FIG. 8(A), the total activation overpotential of the electrolyser (_{cell}), which incorporates the activation overpotentials at both the positive electrode and the negative electrode, was found to drop remarkably precipitously as the temperature increased. Thus, at 45° C., the activation voltage (also called the onset voltage), which is the voltage at which a straight line through data in the linear region intercepts the y-axis, was 1.48 V. At 45° C., the theoretical minimum voltage (E°_{cell}) for water splitting is 1.21 V, meaning that the activation overpotential of the cell, _{cell}, was 1.48-1.21=0.27 V. At 60° C. however, the onset voltage was 1.41 V. As the E°_{cell} for water splitting is 1.20 V at that temperature, the activation overpotential of the cell, _{cell}, was 1.41-1.20=0.21 V.

At 80° C., the theoretical minimum voltage (E°_{cell}) for water splitting is 1.183 V. To this may be added the Ohmic losses deriving from the electrolyte and the resistance of the Ni mesh, both of which may become more substantial at the higher temperature. Given that the conductance of a 6 M KOH solution at 80° C. is 1.3499 S.cm, the expected voltage drop over a 10 mm (=1 cm) inter-electrode gap can be calculated to be 0.0074 V. The voltage drop due to the Ni mesh was similarly calculated to be 5.67×10⁻⁷ V. Accordingly, the minimum theoretical voltage for water-splitting by the cell at 80° C., including the Ohmic losses was: 1.183 (E°)+0.0074+5.67×10⁻⁷=1.90 V. The activation voltage at that temperature, according to FIG. 8(A), was 1.28 V, indicating that the overall activation overpotential of the cell, _{cell}, had declined to an extraordinarily low 0.09 V.

FIG. 8(A) also shows that the current-voltage curve became significantly flattened and closer to linear at 80° C. than at 60° C. and 45° C. It further crossed the y-axis at near to the theoretical minimum potential for water electrolysis (E° 1.18 V at 80° C.). The ‘dogleg’ seen as the current increases at 45° C. and 60° C., in which an initially sharply rising voltage gives way to a less sharply rising, linearly-increasing voltage, is therefore substantially diminished at 80° C. This ‘dogleg’ is highly characteristic of water electrolysis polarisation curves.

To the best of the inventors' knowledge, these results are unprecedented in liquid-phase water electrolysis. It is unknown for the activation overpotential of an electrolyser cell to decline in this way and for its current-voltage curve to flatten out to near-linearity. It is also unprecedented for such a curve to intercept the y-axis at or about the theoretical minimum) (E°) voltage. Indeed, as far as the inventors are aware, only steam electrolyzers that reply on high temperature for their efficiency (e.g. solid-oxide electrolysers, operating at 700-900° C.) display near-linear current-voltage curves that pass through or near to the theoretical minimum voltage. The above embodiment water electrolyser constitutes the intrinsically most energy efficient water electrolyser yet reported.

To illustrate the remarkable nature of this data, the graph in FIG. 8(B) depicts the current-voltage curve at low current densities of the above, ePTFE membrane-based electrolyser at 80° C. (solid line), as it compares to alkaline and PEM electrolysers with very low onset potentials at the same temperature; namely, the “zero-gap” electrolysers of:
(Alkaline electrolyser) Hug and colleagues (dashed line) (see: W. Hug, J. Divisek, J. Mergel, W. Seeger, H. Steeb Int. J. Hydrogen Energy 1992, 17, 699-705).
(PEM electrolyser) Ioroi and co-workers (dotted line), is also depicted (see: T. Ioroi, T. Okub, K. Yasuda, N. Kumagai, Y. Miyazaki J. Power Sources 2003, 124, 385-389.

As can be seen in the graph in FIG. 8(B), the activation overpotential of the Hug electrolyser (_{cell}0.22 V) and the Ioroi electrpolyzer (_{cell}0.21 V) was more than double that of the above ePTFE membrane-based electrolyser (_{cell}0.09 V). That is, on approaching a current density of zero, the voltages in the Hug and Ioroi electrolyzers were ≥0.12 V greater than they would have been without the need for bubble formation and release. They must, necessarily, have been even greater at the higher current densities used during normal operation of these electrolyzers (400-2000 mA/cm²).

Energy efficiency in electrolyzers may be calculated in terms of the lower heating value (LHV) of hydrogen, relative to E° (1.18 V at 80° C.). This comparison therefore reveals that, bubble formation and release decreases the maximum available energy efficiency in the most intrinsically efficient, impedance-optimized “bubbled” electrolyzers to ≤1.18/(0.12+1.18)×100=≤90.8% LHV. That is, the smallest decrease in energy efficiency due to bubble formation and release is 9.2%, which is massive. This percentage is observed only as the current density approaches zero, when very few bubbles are formed. The energy efficiency penalty must, necessarily, be larger—possibly/probably much larger—at higher current densities. It must also be larger in less intrinsically efficient electrolyzers. This may include many apparently high-performing “bubbled” electrolyzers whose polarisation curves only become ohmic (i.e. overcome activation) above 300-500 mA/cm².

In summary: by avoiding bubble formation in example embodiment electrodes and cells, it is possible to substantially improve (by ≥9.2%) the energy efficiency of water electrolysis and potentially realize efficiencies that have hitherto only been available in high-temperature steam electrolysis.

Until now it has not been possible to experimentally determine the minimum decrease in the energy efficiency of water electrolyzers deriving from the need for bubble formation and release.

Similar Overpotential Declines are Observed when a Bubble-Suppression Layer is Overlaid Upon Such Example Embodiment Electrodes

Similar declines in overpotential could be observed when the liquid side layers of example embodiment catalyst-PTFE electrodes were overlaid with a bubble-suppression layer (such as the abovementioned polyethersulfone filter membrane of 0.2 μm average pore diameter, having the tradename: SUPOR200 from Pall Corporation). This confirmed that the decline in overpotential was due to a decrease in the bubbles formed and/or present. Moreover, it indicated that however such a decrease in bubble formation or presence may be achieved, it may result in a decline in the overpotential.

Similar results were obtained when two such example embodiment catalyst-PTFE electrodes were tightly sandwiched against opposite sides of a bubble-suppression layer that was infused with liquid electrolyte.

Similar results were obtained when two such example embodiment catalyst-PTFE electrodes were tightly sandwiched against opposite sides of an assembly containing multiple bubble-suppression layers that were tightly located against each other and infused with liquid electrolyte.

The Nature of the Overpotential Decline—the Activation Overpotential for O₂ Formation is Almost Eliminated

To try to understand the origin and nature of the lowered overpotential, we studied the above example embodiment ePTFE membrane-based electrolyser in a 3-electrode system. A miniature Ag/AgCl reference electrode was introduced into the inter-electrode space of the electrolyser. Two potentiostats were then used to simultaneously monitor the voltage at each of the electrolyser negative electrode and positive electrode relative to the reference electrode, during sweeps to measure current-voltage polarization curves. As the theoretical minimum voltage at each of the positive electrode and negative electrode may be calculated based on the electrolyte pH and temperature, one may then determine the overpotential at each of the negative electrode and positive electrode as a function of the current density during the current-voltage sweep.

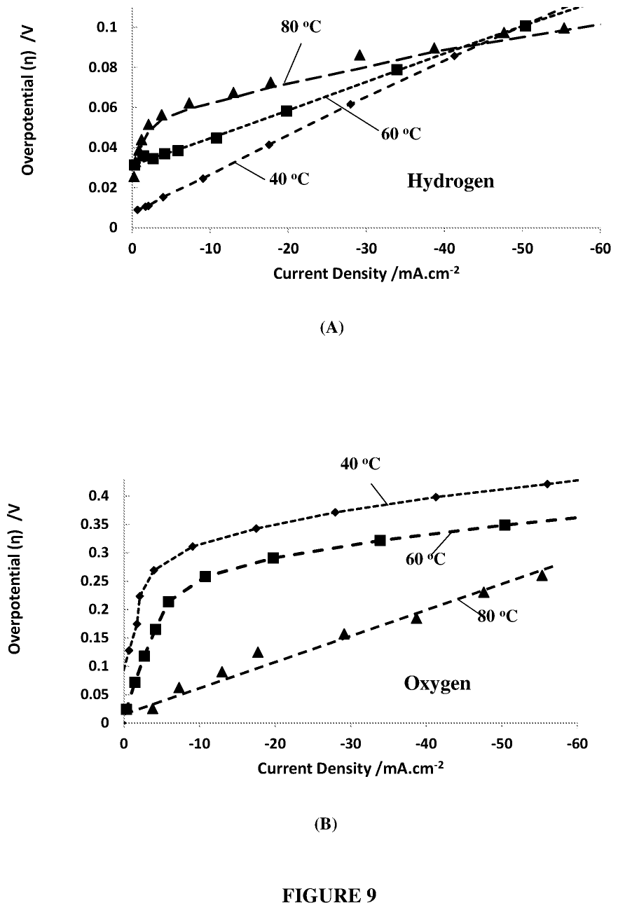

FIG. 9 depicts the negative electrode and positive electrode overpotentials measured in this way at 40° C., 60° C., and 80° C. As can be seen in FIG. 9(A), the overpotential for hydrogen formation from the alkaline electrolyte is relatively small, being below 0.10 V at all current densities studied. It also shows relatively little temperature dependence, being roughly similar at all temperatures examined. To the extent that there is a temperature dependence however, the overpotential for hydrogen formation is lowest at the lower temperatures (40° C.); it increases as the temperature increases. Indeed, it is notable that the overpotential-current curve for hydrogen at the lower temperature, namely 40° C., is linear and passes close to the point of zero overpotential.

By contrast, the overpotential for oxygen formation from the aqueous electrolyte is substantially larger than that of hydrogen. At 40° C., it exceeds 0.3 V above 10 mA/cm² and 0.4 V above 40 mA/cm². However, as the temperature is increased to 80° C., the oxygen overpotential falls precipitously. Its curve also flattens significantly. Thus, the overpotential-current density curve for oxygen is linear and passes close to the point of zero overpotential at the higher temperature, namely 80° C.

These trends are also seen in the activation overpotential for the electrolyzer cell. It can be concluded that the cell overpotential is dominated by the overpotential for oxygen formation from the alkaline 6 M KOH electrolyte.

This dramatic decline in the O₂ overpotential at elevated temperatures (and thereby also the cell activation overpotential) must clearly be due to the ePTFE membrane substrate. The ePTFE membrane vigorously decreased the overpotential for O₂ formation from the water electrolyte. It did that by capillary actions on its surface. It extracted the O₂ gas as it was being formed, allowing for the O₂ catalyst to operate significantly more efficiently and in a way that more closely mirrored the underlying thermodynamics of water oxidation.

Asymmetric Thermal Amplification

As can be seen in FIG. 9(A), the overpotential-current curve for hydrogen was linear and passed close to the point of zero overpotential at the lower temperature, namely 40° C. By contrast, as can be seen in FIG. 9(B), the overpotential-current curve for oxygen was linear and passed close to the point of zero overpotential at the higher temperature, namely 80° C. This data indicated that the lowest cumulative cell overpotential and therefore the maximum performance of the cell, in an electrolyzer of this type (with ePTFE-based electrodes) may be achieved by selectively heating the O₂-generating positive electrode to 80° C. or above, whilst maintaining the H₂-generating negative electrode at near to or below 40° C. This technique is known as asymmetric thermal amplification, which refers to amplifying cell performance by asymmetrically heating or cooling the positive electrode and negative electrode electrodes.

To exploit this feature, the example embodiment cell for the above reaction was modified by adding a secondary electrical circuit through, or to, the positive electrode. This secondary electrical circuit was used to turn the positive electrode into a resistance heater, allowing the positive electrode to be selectively heated. The cell could then be operated in a step-wise fashion, with current first being passed through the secondary circuit to heat the positive electrode up. During this step, the primary circuit that would normally pass current between the positive electrode and negative electrode was open (not closed) so that no current passed between the electrodes. Once the positive electrode was heated up, the next step involved opening the secondary circuit and closing the primary circuit. The resistance heating at the positive electrode was thereby halted and normal cell operation was commenced with current flowing between the positive electrode and negative electrode. These two steps could be carried out rapidly and repeatedly in cyclical succession to thereby bring the positive electrode up to 80° C. and above, whilst the negative electrode remained at 40° C. and below, all the while simultaneously operating the cell.

In another example, the secondary electrical circuit could be added through, or to, the negative electrode. This secondary electrical circuit could be used to turn the negative electrode into a resistance heater, allowing the negative electrode to be selectively heated.

In another example, a third electrical circuit could be added through, or to, the negative electrode. This secondary electrical circuit could be used to turn the positive electrode into a resistance heater, allowing the positive electrode to be selectively heated to a first temperature, and the third electrical circuit could be used to turn the negative electrode into another resistance heater, allowing the negative electrode to be selectively heated to a different second temperature.

Under these conditions, the cell can generate the same or better performance than the cell had when the entire vessel had been heated to 80° C. (which was previously required in order to achieve maximum performance). That is, this approach of asymmetric heating of the electrodes (i.e. asymmetrically heating or cooling the positive electrode or the negative electrode) allowed for equal or better performance than that achieved at high temperature without the need to heat the entire apparatus.

In other words, in certain electrochemical cells, it may be more energy and cost-effective to asymmetrically heat (or cool) one, or both, of the electrodes rather than the entire apparatus. Indeed, “asymmetric thermal amplification” of this type may increase performance in an electrochemical cell without the energy or economic cost normally required.

It is to be understood that asymmetric thermal amplification could equally well be achieved by selective cooling of an electrode. For example, the negative electrode in the above example may be cooled.

Alternatively, examples may involve selective heating of one electrode and selective cooling of the other electrode. For example, the positive electrode in the above example may be heated and the negative electrode cooled.

It is to be further understood that, depending on the particular electrochemical reaction and the particular electrodes used, thermal amplification may, in general, involve:
selective heating of an electrode, either the positive electrode or the negative electrode, or
selective cooling of an electrode, either the positive electrode or the negative electrode, or
a combination of the two, such as, for example, heating of one electrode, either the positive electrode or negative electrode, and cooling of the other electrode, or
heating one electrode to a first temperature, and heating the other electrode to a different second temperature, or
cooling one electrode to a first temperature, and cooling the other electrode to a different second temperature.

It is to be further understood that, in cells with more than one, or many positive electrodes and negative electrodes, thermal amplification may involve:
heating or cooling some or all of the positive electrodes, or
heating or cooling some or all of the negative electrodes, or
a combination of heating some or all of one type of electrode in a cell, either positive electrodes or negative electrodes, whilst simultaneously cooling some or all of the counterpart electrodes.

It is to be further understood that asymmetric thermal amplification may be achieved by any and all types of cooling or heating, howsoever brought about.

Moreover, it is to be further understood that, while asymmetric thermal amplification may be employed in example embodiment cells with example embodiment electrodes, it is not limited to the use of such cells and such electrodes. Any electrodes and any electrochemical cells, without limitation, may be used to carry out thermal amplification.

Efficient H₂/O₂ Fuel Cells Employing ePTFE Membrane-Based Electrodes

Similar overpotential benefits may be observed when example embodiment cells have gases or gas mixtures piped into them as reactants rather than taken out of them as products. In such cells, gases are fed into the gas diffusion electrode; they then react at the three-way solid-liquid-gas interface that is subject to the above-described repulsive capillary actions. The repulsive capillary actions appear, in these cases, to exploit a slightly different effect: they hold the incoming gases in the mouths of the pores of the gas side layer, where those pores interface with the liquid/gel electrolyte. In so doing, they provide for three-way solid-liquid-gas interfaces that are: (1) well-defined, (2) robustly maintained, and, as a result, (3) astonishingly active.

Studies also examined the utility of example embodiment ePTFE membrane-based electrodes layered with catalysts in fuel cell mode, utilizing reaction:

O₂+2 H₂ 2 H₂O+electricity+heat E°_{cell}1.23 V (vs SHE)

The same benchtop cell and physical conditions were used for the fuel cell work, however, instead of collecting H₂ and O₂ generated at the electrodes, high purity H₂ and O₂ at atmospheric pressure was slowly fed into and through the respective gas chambers during these experiments.

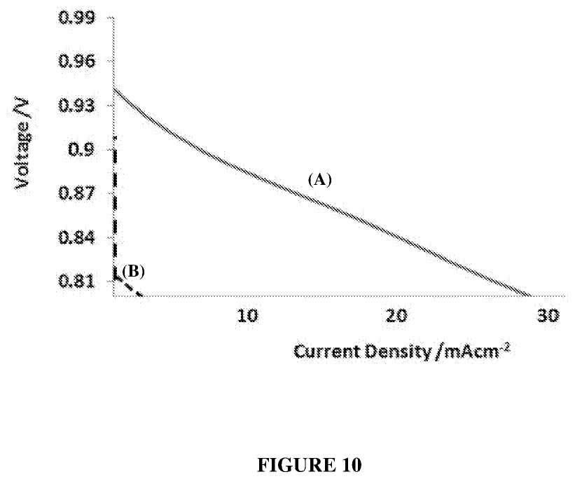

One of the best performing fuel cells employed example embodiment electrodes comprising a liquid side layer containing a mixture of 20% Pd—Pt/CB and PTFE, with a Ni mesh current collector, deposited on a gas side layer comprising an ePTFE membrane (‘20% Pd—Pt/CB+PTFE+Ni-mesh/ePTFE membrane’), at both the positive electrode and negative electrode. The polarization curve after 1 h (80° C.) at 10 mA/cm² in the reverse direction (fuel cell mode), is shown in FIG. 10(A). As can be seen, the cell generated a voltage of 0.88 V at 10 mA/cm².

To assess whether carbon corrosion in the strongly oxidizing environment of the O₂ electrode may have contributed to the current and voltage, we also prepared and tested under identical conditions, a control fuel cell with the same H₂ electrode but with an O₂ electrode in which the catalyst had been replaced with only carbon black; that is, with a carbon black+Ni-mesh/ePTFE membrane electrode. That cell produced a current only below voltages in the low 0.8 V region (FIG. 10(B)). It could thereby be concluded that carbon corrosion at the O₂ electrode did not contribute to the performance of the fuel cell having 20% Pd—Pt/CB+PTFE+Ni-mesh/ePTFE membrane at both electrodes at 10 mA/cm², which exhibited a voltage of 0.88 V.

When the electrolyser having Raney Ni+CB+PTFE+Ni-mesh/ePTFE membrane (negative electrode) and NiCo₂O₄+PTFE+Ni-mesh/ePTFE membrane (positive electrode) was combined with the above fuel cell (20% Pt—Pd/CB+PTFE+Ni-mesh/ePTFE membrane at both electrodes), then the system displayed a notional round-trip energy efficiency after 1 h at 10 mA/cm² and 80° C. in each direction, of 72.6% (assuming full conservation of heat). This exceeds that achieved by, for example, the highest-performing regenerative PEM fuel cell electrolyser of Ioroi and colleagues, which yielded a round-trip energy efficiency at 80° C. and 10 mA/cm² in each direction, of 66.4% (see: T. Ioroi, T. Okub, K. Yasuda, N. Kumagai, Y. Miyazaki J. Power Sources 2003, 124, 385-389). To the best of our knowledge, this round-trip efficiency is the highest yet recorded for electricity storage and recovery using hydrogen as the energy carrier.

Conclusions

The development of water-splitting catalysts with substantially lowered overpotentials has, for decades, constituted a key objective in science. While that field is now truly mature, with few improved new catalysts being discovered, the present examples describe a new approach that may be used to amplify the energy efficiency of existing catalysts. The new approach utilizes a gas side layer, for example a ePTFE membrane, upon which a liquid side layer incorporating catalysts are deposited, to thereby decrease their overpotentials. The capillary actions created diminish the bubbles formed on the electrodes, thereby diminishing the cell overpotentials. This allows for the fabrication of water electrolyzers of unparalleled energy efficiency.

### Example Seawater Electrolysis be Facilitated by Example Embodiment Cells

A water electrolyser is designed to split water electrochemically into its component gases, hydrogen (H₂) and oxygen (O₂) according to the reactions:

$$\begin{matrix}Negative electrode \text{:} 4 {H}^{+} + 4 e \text{-} 4 {H}_{2} ( g ) {E}^{o} 0.00 V ( vs SHE ) & ( 4 ) \\ Positive electrode \text{:} 2 {H}_{2} O {O}_{2} ( g ) + 4 {H}^{+} + 4 {e}^{-} {E}^{o} - 1.229 V ( vs SHE ) & ( 5 ) \\ 2 {H}_{2} O {O}_{2} ( g ) + 2 {H}_{2} ( g ) {E}_{cell}^{o} - 1.229 V ( vs SHE ) & ( 6 )\end{matrix}$$

The half-reaction that occurs at the positive electrode would normally be the oxygen evolution reaction (OER) shown in equation (5) above. If, however, chloride ions (Cl⁻) are present in the water, then the following half-reaction typically takes place preferentially:

Positive electrode: 2 Cl⁻ Cl₂+2e E°−1.3604 V (vs SHE) (7)

While the half-reaction for chlorine (Cl₂) formation (reaction (7)) is thermodynamically less favourable than that for oxygen generation (reaction (5)), it has a substantially lower bubble overpotential. That is, the additional energy required to form O₂ in the form of bubbles is very much higher than that required to form Cl₂. When performed on the industry standard catalyst, Pt black, the activation overpotential for O₂ formation at 25° C. is at least 0.77 V, while that of Cl₂ formation is only about 0.08 V. This large additional voltage requirement overwhelms the smaller disparity in E° between reactions (5) and (7). As a result, in the presence of Cl⁻ ions, Cl₂ evolution generally occurs at the positive electrode in standard commercial electrolyzers. In so doing, it destroys the reaction efficiency of the cell and generates the undesirable and poisonous Cl₂ product instead of O₂. Depending on the pH of the electrolyte, the Cl₂ may form side-products, such as hypochlorous acid (HOCl; pH 3-7) or hypochlorite (OCl⁻; pH>7).

Seawater is one of the most abundant and accessible resources on Earth. It contains a multiplicity of inorganic ions, organic molecules and biological materials, whose concentrations vary, often dramatically, around the world. Typical seawater has a pH of 8.4-8.8 and contains common ions like Cl⁻, Na⁺, Me⁺, SO₄²⁻, Ca²⁺, K⁺ and HCO₃⁻ (listed in order of decreasing concentration). Of these, Na⁺ and Cl⁻ are the most abundant, with standard mean chemical concentrations of [Na⁺] 0.47 M and [Cl⁻] 0.55 M, respectively. If subjected to electrolysis, seawater may undergo a variety of oxidation processes, of which the most important is Cl₂ formation at the positive electrode.

At the present time, the only true catalyst known to be capable of generating Cl₂-free O₂ from seawater is the naturally-occurring tetra-Mn oxo cluster known as the Photosystem II Water Oxidation Centre (PSII-WOC), within the photosynthetic apparatus of hypersaline aquatic organisms. It has, to date, not proved possible to develop abiological catalysts that are intrinsically capable of generating bulk quantities of pure O₂ from pH-unmodified seawater at the positive electrode of a water electrolyser.

To further elucidate the mechanism by which the O₂ overpotential was decreased by the example embodiment positive electrode electrode in the previous example, we describe a comparable electrolyser using pH-unmodified seawater and artificial seawater as an electrolyte. Polypropylene-backed Preveil™ expanded PTFE (ePTFE) membranes (‘ePTFE membrane’), produced by General Electric Energy were used as the gas side layers in all experiments. The membranes had pores of average diameter 0.2 μm; they only flooded at overpressures of >4 bar.

The Example Embodiment Electrolyzer

An electrolyzer was fabricated that contained the same positive electrode as used previously, but with a fine stainless steel (SS) mesh current carrier instead of a Ni mesh. That is, NiCo₂O₄+PTFE+SS-mesh/ePTFE membrane was used as the positive electrode, where the quantities employed were 262 g/m² of cubical NiCo₂O₄ spinel and 240 g/m² PTFE. The modification to the mesh was made because, at the pH of seawater (8.4-8.8), anodic Ni (E_{SHE}>0.7 V) may be favoured to form soluble Ni²⁺ according to its Pourbaix diagram. To avoid any possible complications arising from the Ni mesh, a stainless steel mesh current carrier was used instead.

For the negative electrode, we used a catalyst mixture comprising 10% Pt on carbon black (Pt/CB) (0.71 g Pt/m²), carbon black (CB) (21 g/m²) and PTFE binder (21 g/m²), with a Ni mesh current collector, deposited on ePTFE membrane (‘10% Pt/CB+PTFE+Ni-mesh/ePTFE membrane’).

The above electrolyser was fabricated as a benchtop test cell as described previously. The cell was filled with an electrolyte of seawater or artificial seawater.

Operation of the Example Embodiment Electrolyzer With Seawater as Electrolyte

Electrochemical testing was carried out on freshly-collected seawater that had been filtered to remove particulate materials. As continuous pumping of the seawater through the test electrolyzer cell was not possible, initial studies examined whether and for how long the static seawater electrolyte in the cell would be able to resist pH changes at electrolytic current densities of interest. A chronoamperogram at 10 mA/cm² initially yielded a promising, steady voltage. However, within <5 min the voltage became unstable due to pH changes that altered the electrolyte nature of the seawater. The addition of a standard borate buffer directly to the seawater (without dilution) however, maintained the static seawater in the cell near to its native pH (a buffered pH of 8.788 vs. a native pH of 8.6) and greatly extended the period over which electrolysis could be tested.

At 80° C., the E°_{cell} for water-splitting (H₂O H₂^{negative electrode}+O₂^{positive electrode}) is −1.183 V. The equivalent E°_{cell} for Cl₂ formation (H₂O H₂^{negative electrode}+Cl₂^{positive electrode}), which is −1.3604 V at 25° C., can be calculated using the respective temperature coefficients to be −1.2917 V at 80° C. Thus, between the 2-electrode cell voltages of −1.183 V and −1.2917 V, it is theoretically possible to form O₂ but not Cl₂. At cell voltages above −1.2917, Cl₂ formation is possible, although O₂ formation is theoretically favoured. As noted above, in practice, common catalysts do not generate O₂ in this voltage window and preferentially generate Cl₂ above −1.2917 V if Cl⁻ ions are present in solution.

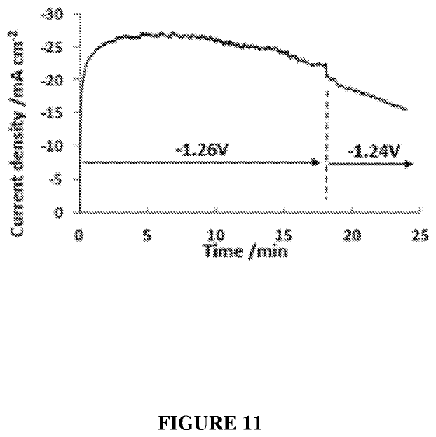

Accordingly, to test whether the above electrolyzer would be able to preferentially split seawater, we set the electrolyzer to 2-electrode voltages of −1.26 V and, later, to −1.24 V and measured the resulting chronoamperogram, which is depicted in FIG. 11. Complementary, in-situ three-electrode measurements using a separate potentiostat and a miniature Ag/AgCl reference electrode in the inter-electrode space of the electrolyser, were used to simultaneously monitor the voltage at the positive electrode relative to the reference electrode. These showed that the potential at the positive electrode under the above cell voltages was 0.771-0.774 V (vs RHE), which was marginally above the theoretical minimum voltage for O₂ formation at 80° C. and pH 8.788 of 0.769 V.

As can be seen in FIG. 11, a notable current of 15-27 mA/cm² was observed over 25 min of operation. The periodic voltage fluctuations in the current derived from small temperature swings that occurred in the surrounding water bath as the heater-controller tried to maintain a fixed 80° C. temperature in the face of a cooling effect created by the cell, which was operating at a potential far below the thermoneutral voltage for water electrolysis (1.482 V).

During this time, gases were seen to be produced at the negative electrode and positive electrode. These gases were allowed to pass from their respective gas chambers through thin, clear polymer tubes, into separate, small glass vials containing about 25 mL de-ionized water each, where they bubbled out. The gas produced by the positive electrode could be seen to be colourlesss, consistent with it not being Cl₂, which has a yellow-green colour. The volume of the gases produced was estimated by videoing, in extreme close-up, the bubbles released by the respective tubes in each of the water-filled vials. A finely graduated measuring ruler was placed immediately behind the bubble release point and served as a reference for later estimating the size, and thereby the volume, of each bubble on individual frames of the video. There were sufficient H₂ gas bubbles to be accurately collected and measured in a small, upturned measuring cylinder filled with water. The above measurements confirmed that the expected volume of gas for water-splitting, with oxygen-evolution at the positive electrode, was obtained. The gas produced at the positive electrode was confirmed to be O₂ by GC analysis using a Shimadzu GC-8A gas chromatograph with attached sample loop.

Near to the end of the above period, we observed that the positive electrode O₂ gas was no longer passing through the ePTFE membrane substrate at the positive electrode, with bubbles instead forming in the electrolyte and rising into the cell headspace. Upon opening the cell, it became apparent that the spinel catalyst at the positive electrode had exfoliated and re-deposited, coating the positive electrode with a thin film that appeared to block gas transport through the ePTFE membrane. Exfoliation and re-deposition of spinel metal oxide catalysts at the positive electrode is a common problem in seawater electrolyzers.

To determine whether any Cl₂ had been formed at the positive electrode, we checked the water in the reservoir through which the positive electrode gas had been bubbled. The test involved the use of commercial analytical test strips (Merckoquant®) that are capable of detecting 0.5 mg Cl₂/L. The test strips indicated an absence of chlorine in the reservoir water, at least above the limit of detection of 12.5 μg which equated to about 0.4% by weight of the O₂ generated.

Operation of the Example Embodiment Electrolyzer with Artificial Seawater as Electrolyte

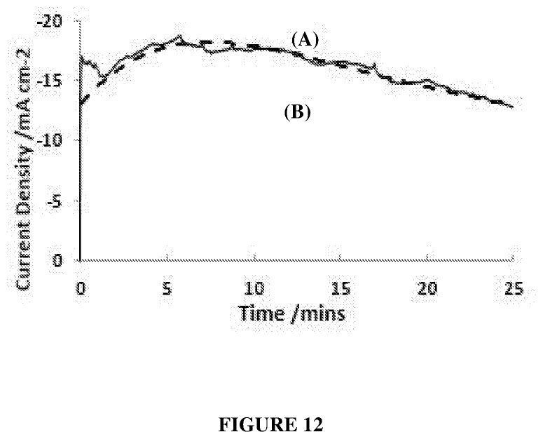

To confirm these results and determine whether the borate buffer had an influence, we also tested an artificial seawater electrolyte, which comprised an aqueous 0.3 M NaCl solution, with and without borate buffer. The tests were carried out in the above cell, with the 2-electrode cell voltage set to −1.26 V (FIG. 12). With the borate buffer the electrolyte pH was 8.80. Without the borate buffer, the electrolyte pH was 7.60.

FIG. 12 depicts the resulting chronoamperogram. The data with and without the borate buffer at −1.26 V were very similar, taking into account the different pHs of these electrolytes. A lower pH (7.6 vs 8.8) solution containing fewer ions would be expected to produce a marginally lower curve. Importantly, the data for the artificial seawater with the borate buffer was comparable to that of the seawater with the borate buffer, falling in the 15-25 mA/cm² range.

It can, consequently, be concluded that the presence of the borate buffer had little effect on the seawater electrolysis described in the earlier section.

The Origin of the Lowered Activation Overpotential for O₂-Formation from Water

As noted above, a well-known and characteristic feature of seawater electrolysis is the formation of Cl₂ at the positive electrode because of the large bubble overpotential of O₂. The ePTFE membrane-based electrolyser described above however, generated pure O₂ at the positive electrode from pH-unmodified seawater, with no Cl₂ detected above the minimum theoretical cell voltage for water-splitting, namely, −1.183 V at 80° C. To the best of the inventors' knowledge, this is unprecedented for an abiological catalyst. No man-made catalyst has been shown to be capable of generating bulk O₂ from pH-unmodified seawater at an positive electrode voltage below the thermodynamic minimum for Cl₂ formation.

This result was also important for the fact that it indicated that the example embodiment positive electrode largely eliminated the O₂ bubble overpotential.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

What is claimed is:

1. An electrochemical cell, comprising:
a liquid electrolyte;
a first electrode in contact with the liquid electrolyte, the first electrode comprising:
a liquid-side layer having a first surface in direct contact with a gas-side layer;
the gas side layer made of a material exhibiting a capillary pressure with the electrolyte more negative than −0.1 bar;
the liquid-side layer made of a material exhibiting a capillary pressure with the electrolyte more positive than +0.1 bar; and
a gradient of capillary pressure in the electrolyte between the liquid-side layer and the gas-side layer is greater than or equal to one bar.

2. The electrochemical cell of claim 1, wherein the capillary pressure of a material is twice a surface tension of the electrolyte multiplied by the cosine of a contact angle of the electrolyte with the material, divided by an average pore radius of the material.

3. The electrochemical cell of claim 1 or 2, further comprising a hydrophilic non-conductive bubble-suppression layer at least partially infused with electrolyte and in direct contact with a second surface of the liquid-side layer opposite the first side of the liquid-side layer, the bubble-suppression layer made of a material exhibiting a capillary pressure with the electrolyte more positive than the liquid-side layer capillary pressure.

4. The electrochemical cell of claim 3, wherein the bubble-suppression layer is made of an unmodified polyethersulfone membrane.

5. The electrochemical cell of any one of claims 1-4, wherein the gas-side layer comprises an expanded polytetrafluoroethylene (ePTFE) membrane.

6. The electrochemical cell of any one of claims 1-5, wherein the liquid-side layer comprises a catalyst material and fibrillated strands of PTFE entangling structures in the gas-side layer.

7. The electrochemical cell of any one of claims 1-6, wherein the liquid-side layer comprises a catalyst material and fibrillated strands of PTFE entangling structures of a bubble-suppression layer in contact with the liquid-side layer opposite the gas-side layer.

8. The electrochemical cell of any one of claims 1-7, wherein the liquid-side layer has a higher density of fibrillated PTFE strands adjacent to its first side than its second side.

9. The electrochemical cell of any one of claims 1-7, wherein the liquid-side layer has a uniform density of fibrillated PTFE strands throughout its thickness.

10. The electrochemical cell of any one of claims 1-7, wherein the liquid-side layer has a higher density of fibrillated PTFE strands adjacent to its second side than its first side.

11. The electrochemical cell of any one of claims 1-7, wherein the electrolyte is a 6 M aqueous solution of potassium hydroxide (KOH).

12. The electrochemical cell of any one of claims 1-11, wherein the liquid-side layer comprises conductive particles.

13. The electrochemical cell of any one of claims 1-12, wherein the liquid-side layer comprises a conductive substrate.

14. The electrochemical cell of any one of claims 1-13, wherein the liquid-side layer has a different porosity, average pore size, hydrophobicity, or thickness than the gas-side layer.

15. The electrochemical cell of any one of claims 1-14, further comprising a heating element configured to heat the first electrode and a controller to maintain the first electrode at a different temperature than a counter-electrode.

16. The electrochemical cell of any one of claims 1-15, wherein a fluid pressure of the electrolyte is greater than a gas pressure in a gas space adjacent to the gas-side layer.

17. The electrochemical cell of any one of claims 1-16, wherein the second side of the liquid-side layer of the first electrode directly contacts a hydrophilic bubble-suppression layer exhibiting a capillary pressure with the electrolyte more positive than the liquid-side layer capillary pressure, and further comprising a second electrode with a liquid-side layer directly contacting the bubble-suppression layer.

18. The electrochemical cell of claim 17, wherein the bubble-suppression layer is a single layer of unmodified polyethersulfone membrane.

19. The electrochemical cell of claim 17, wherein the bubble-suppression layer is multiple layers of unmodified polyethersulfone membrane.

20. The electrochemical cell of any one of claims 1-19, wherein the bubble-suppression layer is less than 2 mm thick.

21. A method of operating the electrochemical cell as claimed in any one of claims 1-20, comprising asymmetrically heating or cooling the first electrode while electrochemical reactions occur in the cell.

22. A method of operating the electrochemical cell as claimed in any one of claims 1-20, wherein the electrolyte comprises seawater and comprising electrolyzing the seawater to produce oxygen without producing chlorine gas.

23. A method of making a gas diffusion electrode, the method comprising:
preparing a mixture of PTFE powder and a catalyst material;
applying the mixture to a surface of a bubble-suppression layer material while applying a shear force between the mixture and the bubble-suppression layer to thereby fibrillate PTFE particles at the bubble-suppression layer surface; and
after applying the mixture to the bubble-suppression layer, pressing a conductive substrate into the mixture.

24. The method of claim 23, further comprising pressing an expanded PTFE membrane onto the mixture while applying a shear force to thereby fibrillate PTFE particles at a surface of the expanded PTFE membrane.

25. A method of making a gas diffusion electrode, the method comprising:
preparing a mixture of PTFE powder and a catalyst material;
applying the mixture to a surface of an expanded PTFE membrane while applying a shear force between the mixture and the expanded PTFE membrane to thereby fibrillate PTFE particles at the expanded PTFE membrane surface; and
after applying the mixture to the expanded PTFE membrane, pressing a conductive substrate into the mixture.

26. The method of claim 25, further comprising pressing a bubble suppression layer onto the mixture while applying a shear force to thereby fibrillate PTFE particles at a surface of the bubble suppression layer.
